(19) United States
(12) Patent Application Publication
(10) Pub. No.: US 2026/0072339 A1
(43) Pub. Date: Mar. 12, 2026

(54) LASER LIGHT SOURCE DEVICE AND PROJECTION SYSTEM

(71) Applicant: HISENSE LASER DISPLAY CO., LTD., Shandong (CN)

(72) Inventor: Yaqian LI, Shandong (CN)

(21) Appl. No.: 19/386,518

(22) Filed: Nov. 12, 2025

Related U.S. Application Data
(63) Continuation of application No. PCT/CN2024/119728, filed on Sep. 19, 2024.

(30) Foreign Application Priority Data
Sep. 28, 2023 (CN) 202311281815.7
Feb. 28, 2024 (CN) 202410219541.7
Feb. 28, 2024 (CN) 202420370139.4

(51) Int. Cl. G03B 33/12; G03B 21/20

(52) U.S. Cl. CPC G03B 33/12; G03B 21/2013; G03B 21/2033; G03B 21/2066; G03B 21/2073; G03B 21/208

(57) ABSTRACT

A laser light source apparatus and a projection system are disclosed. The laser light source apparatus includes: a light emitting assembly, including a first laser and a second laser, where each of the first laser and the second laser includes a plurality of laser chips for emitting laser beams of three colors, the first laser and the second laser are arranged along a first direction; the plurality of laser chips in each of the first laser and the second laser are arranged into a first light emitting region and a second light emitting region, and the first light emitting region and the second light emitting region are arranged along a second direction; and a light combining assembly, at light emitting sides of the first laser and the second laser.

### CROSS-REFERENCE TO RELATED APPLICATIONS

This application is a continuation application of International Application No. PCT/CN2024/119728, filed on Sep. 19, 2024, which claims priorities to Chinese Patent Application No. 202311281815.7, filed with the China National Intellectual Property Administration on Sep. 28, 2023; Chinese Patent Application No. 202420370139.4, filed with the China National Intellectual Property Administration on Feb. 28, 2024; and Chinese Patent Application No. 202410219541.7, filed with the China National Intellectual Property Administration on Feb. 28, 2024, all of which are hereby incorporated by reference in their entireties.

### TECHNICAL FIELD

The present application relates to the technical field of projection, and particularly to a laser light source apparatus and a projection system.

### BACKGROUND

Projection display is a technology that a light source is controlled by plane image information, and an optical system and a projection space are used to magnify an image and display the image on a projection surface. With the development of projection display technology, projection display is gradually applied to business activities, conferences and exhibitions, science and education, military command, traffic management, centralized monitoring and advertising entertainment and other fields. The projection display also meets requirements of large screen display due to its large display screen size, clear display and other advantages.

Compared with other light sources, a laser light source has advantages of high color gamut and high brightness, which makes it widely used in the field of projection. At present, the mainstream application of lasers has been upgraded from monochromatic lasers to three-color lasers. Based on limitation of the current laser design, a single laser cannot meet use requirements, and at least two lasers are needed for light combination.

### SUMMARY

Embodiments of the present application provide a laser light source apparatus, including:
a light emitting assembly, including a first laser and a second laser, where each of the first laser and the second laser includes a plurality of laser chips for emitting laser beams of three colors, the first laser and the second laser are arranged along a first direction; the plurality of laser chips in each of the first laser and the second laser are arranged into a first light emitting region and a second light emitting region, and the first light emitting region and the second light emitting region are arranged along a second direction; wavelengths of laser beams emitted from the first light emitting region and the second light emitting region are different; the first light emitting region of the first laser and the second light emitting region of the second laser are arranged adjacently along the first direction, and are centrally aligned along the first direction; the second light emitting region of the first laser and the first light emitting region of the second laser are arranged adjacently along the first direction, and are centrally aligned along the first direction; the first direction and the second direction are perpendicular to each other; and
a light combining assembly, at light emitting sides of the first laser and the second laser, for combing a laser beam emitted from the first light emitting region of the first laser and a laser beam emitted from the second light emitting region of the second laser, and combining a laser beam emitted from the second light emitting region of the first laser and a laser beam emitted from the first light emitting region of the second laser, and emitting a laser beam combined along the first direction, where the first direction is parallel to a direction of a slow axis of the laser beam combined, a divergence angle of a laser beam, emitted from the laser chip, along a slow axis of the laser beam emitted from the laser chip is smaller than a divergence angle of the laser beam, emitted from the laser chip, along a fast axis of the laser beam emitted from the laser chip, a divergence angle of a laser beam, emitted from the light emitting assembly, along a slow axis of the laser beam emitted from the light emitting assembly is larger than a divergence angle of the laser beam, emitted from the light emitting assembly, along a fast axis of the laser beam emitted from the light emitting assembly.

Embodiments of the present application further provide a laser light source apparatus, including:
a first laser and a second laser, where the first laser is used for emitting laser beams with at least two different wavelengths, and different laser beams emitted from the first laser have different polarization directions, the laser beam emitted from the first laser includes a first laser beam with a first wavelength;
where the second laser is used for emitting a second laser beam with the first wavelength, a polarization direction of the second laser beam is the same as a polarization direction of the first laser beam;
a polarization light combining assembly, including a polarization adjusting element and a polarization light combining element, where the polarization adjusting element is arranged at a light emitting side of one of the first laser and the second laser, to change the polarization direction of one of the first laser beam and the second laser beam, the polarization light combining element is at light emitting paths of the first laser and the second laser, the polarization light combining element is used for reflecting the laser beam of one of the first laser and the second laser and transmitting the laser beam of the other one of the first laser and the second laser; and
a light homogenizing assembly, for homogenizing the laser beam emitted from the polarization light combining element.

Embodiments of the present application further provide a laser light source apparatus, including:
a light emitting assembly, including a plurality of lasers emitting laser beams;
a polarization light combining assembly, including a polarization light combining element and a polarization adjusting element, where the polarization adjusting element is used for adjusting polarization directions of parts of the laser beams of the plurality of lasers, to adjust laser beams with the same polarization direction to laser beams with different polarization directions, and the polarization light combining element is used for combining the laser beams with different polarization directions; and
a light homogenizing assembly, for homogenizing the laser beams combined.

Embodiments of the present application further provide a projection system, including: any one of the above laser light source apparatuses, an illumination system and a projection lens;
where the illumination system includes a light homogenizing element, a shaping lens and a light modulator at a light emitting side of the laser light source apparatus;
the projection lens is at a light emitting side of the light modulator.

### BRIEF DESCRIPTION OF FIGURES

FIG. 1 is a first schematic diagram of a planar structure of a laser according to embodiments of the present application;

FIG. 2 is a second schematic diagram of a planar structure of a laser according to embodiments of the present application;

FIG. 3 is a schematic diagram of an arrangement of lasers in related art;

FIG. 4 is a schematic diagram of a combined light path of lasers shown in FIG. 3;

FIG. 5A is a schematic diagram of a combined light spot of the combined light path shown in FIG. 4;

FIG. 5B is a schematic diagram of a light emitting path of a laser chip according to embodiments of the present application;

FIG. 6 is a first schematic diagram of an arrangement of lasers according to embodiments of the present application;

FIG. 7 is a second schematic diagram of an arrangement of lasers according to embodiments of the present application;

FIG. 8 is a first schematic structural diagram of a laser light source apparatus according to embodiments of the present application;

FIG. 9 is a schematic side view of a laser light source apparatus shown in FIG. 8;

FIG. 10 is a second schematic structural diagram of a laser light source apparatus according to embodiments of the present application;

FIG. 11 is a schematic diagram of a principle of a light path of a transparent flat plate according to embodiments of the present application;

FIG. 12 is a schematic diagram of a combined light spot of a combined light path shown in FIG. 10;

FIG. 13 is a third schematic structural diagram of a laser light source apparatus according to embodiments of the present application;

FIG. 14 is a schematic side view of a laser light source apparatus shown in FIG. 13;

FIG. 15 is a fourth schematic structural diagram of a laser light source apparatus according to embodiments of the present application;

FIG. 16 is a schematic diagram of a principle of a light path of a prism according to embodiments of the present application;

FIG. 17 is a schematic diagram of a light spot of a light path shown in FIG. 16;

FIG. 18 is a fifth schematic structural diagram of a laser light source apparatus according to embodiments of the present application;

FIG. 19 is a schematic side view of a laser light source apparatus shown in FIG. 18;

FIG. 20 is a sixth schematic structural diagram of a laser light source apparatus according to embodiments of the present application;

FIG. 21 is a seventh schematic structural diagram of a laser light source apparatus according to embodiments of the present application;

FIG. 22 is an eighth schematic structural diagram of a laser light source apparatus according to embodiments of the present application;

FIG. 23 is a ninth schematic structural diagram of a laser light source apparatus according to embodiments of the present application;

FIG. 24 is a schematic side view of a laser light source apparatus shown in FIG. 23;

FIG. 25 is a tenth schematic structural diagram of a laser light source apparatus according to embodiments of the present application;

FIG. 26 is a schematic side view of a laser light source apparatus shown in FIG. 25;

FIG. 27 is a schematic diagram of a combined light spot according to embodiments of the present application;

FIG. 28 is an eleventh schematic structural diagram of a laser light source apparatus according to embodiments of the present application;

FIG. 29 is a twelfth schematic structural diagram of a laser light source apparatus according to embodiments of the present application;

FIG. 30 is a schematic structural diagram of a projection system according to embodiments of the present application;

FIG. 31 is a schematic structural diagram of a light source apparatus;

FIG. 32 is a thirteenth schematic structural diagram of a laser light source apparatus according to embodiments of the present application;

FIG. 33 is a fourteenth schematic structural diagram of a laser light source apparatus according to embodiments of the present application;

FIG. 34 is a fifteenth schematic structural diagram of a laser light source apparatus according to embodiments of the present application;

FIG. 35 is a sixteenth schematic structural diagram of a laser light source apparatus according to embodiments of the present application;

FIG. 36 is a seventeenth schematic structural diagram of a laser light source apparatus according to embodiments of the present application;

FIG. 37 is a schematic diagram of a light spot of a first laser before light combination according to embodiments of the present application;

FIG. 38 is a schematic diagram of a light spot after light combination between the first laser and the second laser according to embodiments of the present application;

FIG. 39 is an eighteenth schematic structural diagram of a laser light source apparatus according to embodiments of the present application;

FIG. 40 is a nineteenth schematic structural diagram of a laser light source apparatus according to embodiments of the present application;

FIG. 41 is a twentieth schematic structural diagram of a laser light source apparatus according to embodiments of the present application;

FIG. 42 is a twenty-first schematic structural diagram of a laser light source apparatus according to embodiments of the present application.

### DETAILED DESCRIPTION

In order to make the above objects, features and advantages of the present application more apparent, the present application will be further illustrated below in combination with the drawings and embodiments. However, embodiments can be implemented in various forms and should not be understood as being limited to embodiments illustrated here; and on the contrary, these embodiments are provided to make the present application more comprehensive and complete, and the concept of embodiments is fully conveyed to those skilled in the art. The same reference numbers represent the same or similar structures in the drawings, so the repeated description thereof will be omitted. The words expressing the positions and directions described in the present application are all intended to illustrate by taking the drawings as examples, but can also be changed as needed, where the changes made are all contained in the protection scope of the present application. The drawings of the present application are merely intended to illustrate the relative position relationship, but not represent the real proportion.

The projection display is a technology that a light source is controlled by plane image information, and an optical system and a projection space are used to magnify an image and display the image on a projection surface. With the development of projection display technology, projection display is gradually applied to business activities, conferences and exhibitions, science and education, military command, traffic management, centralized monitoring and advertising entertainment and other fields. The projection display also meets requirements of large screen display due to its large display screen size, clear display and other advantages.

Compared with other light sources, the laser light source has advantages of high color gamut and high brightness, which makes it widely used in the field of projection. MCL (Multi Chip LD) packaging laser has advantages of small volume, high integration and low cost.

The current MCL laser generally includes a plurality of laser chips. The plurality of laser chips can be arranged in an array to form a plurality of rows and columns. The laser chips are packaged in a frame body. A light emitting side of the laser chip can be provided with a reflecting mirror. The reflecting mirror can reflect a laser beam emitted from a corresponding laser chip, and the laser beam is emitted after being collimated by a collimating lens.

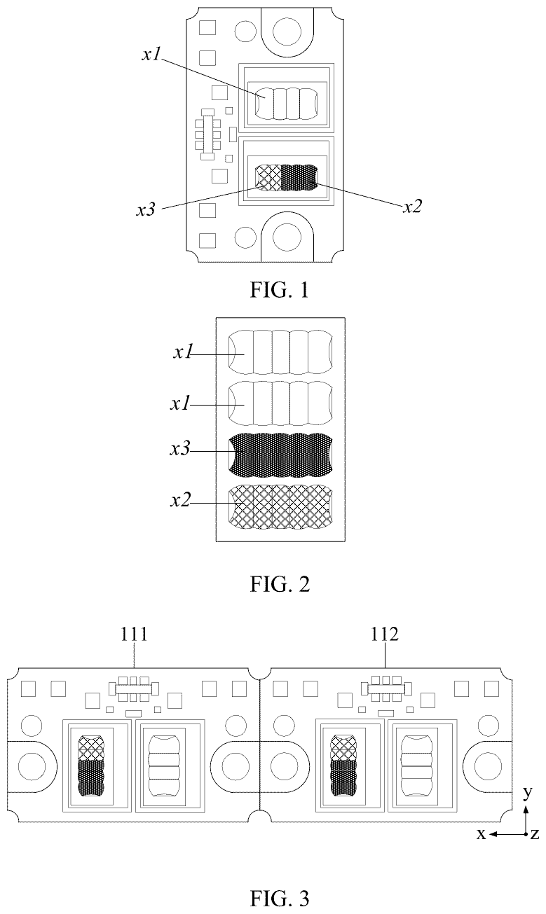

The laser chips in the laser may include a plurality of types for emitting laser beams of different wavelengths. As shown in FIG. 1 and FIG. 2, the laser may include a first laser chip x1, a second laser chip x2, and a third laser chip x3. The wavelengths of the laser beams emitted from the first laser chip x1, the second laser chip x2, and the third laser chip x3 are different.

In some embodiments, as shown in FIG. 1, the number of first laser chips x1 is greater than number of second laser chips x2, and is also greater than the number of third laser chips x3. The first laser chips x1 are arranged in a row, and the second laser chips x2 and the third laser chips x3 are arranged in a row.

In some embodiments, as shown in FIG. 2, the number of first laser chips x1 is the sum of the number of third laser chips x3 and the number of second laser chips x2. The first laser chips x1 are arranged in two rows, the second laser chips x2 are arranged in a row, and the third laser chips x3 are arranged in a row.

Optionally, the first laser chip x1 may be a red laser chip, the second laser chip x2 may be a green laser chip, and the third laser chip x3 may be a blue laser chip. The red laser chip can emit a red laser beam, the green laser chip can emit a green laser beam, and the blue laser chip can emit a blue laser beam.

It should be noted that the arrangement of the laser chips shown in FIG. 1 and FIG. 2 is for illustration only. In practical applications, the type of the laser chip included in the laser, the wavelength of the laser beam emitted from each laser chip, and the number and arrangement of each laser chip are not limited.

In order to improve brightness of a projection apparatus, a single laser cannot meet the use requirements, and at least two lasers are needed to combine light. When light is combined for two lasers shown in FIG. 1, the arrangement is shown in FIG. 3. The two lasers are divided into a first laser 111 and a second laser 112. The first laser 111 and the second laser 112 are arranged along a first direction x, and an overall shape of the frame body of the laser is rectangular. Long sides of the first laser 111 and the second laser 112 are parallel to the first direction x, and the first laser 111 and the second laser 112 are arranged in the same direction along the first direction x.

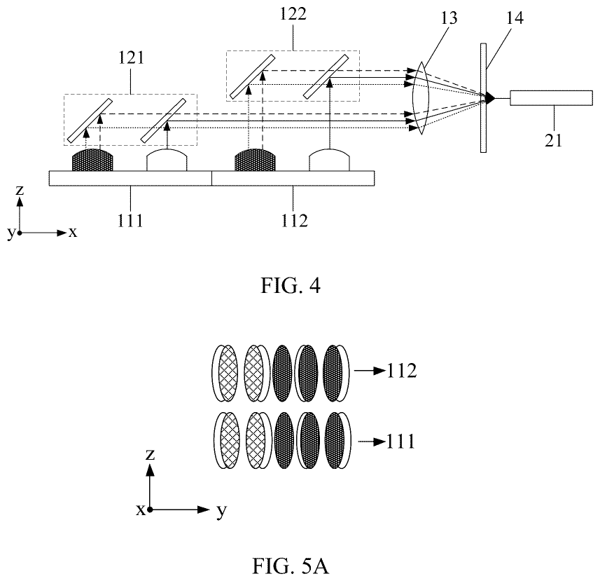

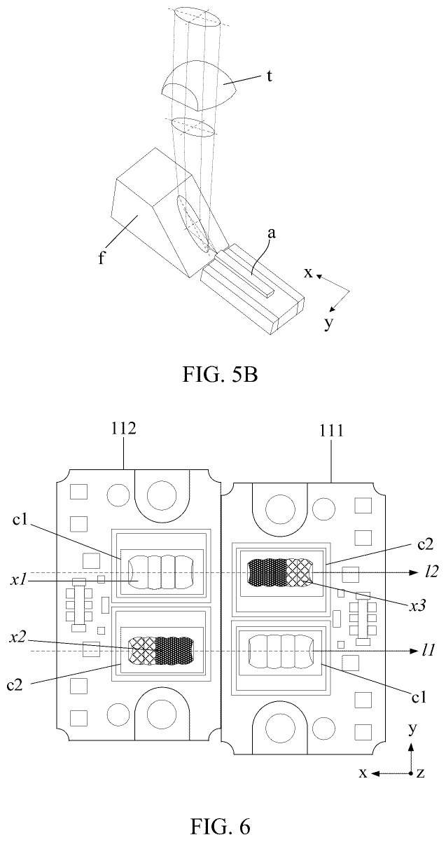

FIG. 4 is a schematic diagram of a combined light path of lasers shown in FIG. 3. When light is combined for the first laser 111 and the second laser 112, a first assembly 121 is arranged at a light emitting side of the first laser 111, and a second assembly 122 is arranged at a light emitting side of the second laser 112. In order to avoid light blocking, the first assembly 121 and the second assembly 122 need to be staggered in a third direction z. The first assembly 121 can combine laser beams with different wavelengths emitted from the first laser 111 and emit laser beams combined along the first direction x. The second assembly 122 can combine laser beams with different wavelengths emitted from the second laser 112 and emit laser beams combined along the first direction x. The combined light spot is as shown in FIG. 5A. The combined light spot of the laser beams emitted from the first laser 111 corresponds to a row of light spots in a lower part of FIG. 5A. The combined light spot of the laser beams emitted from the second laser 112 correspond to a row of light spots in an upper part of FIG. 5A. The combined laser beams also need to be converged by a lens 13, and enters a light homogenizing element 21 after passing through a diffusion sheet 14.

Many lasers used in the laser light source apparatus are semiconductor lasers. As shown in FIG. 5B, a laser chip a is composed of a plurality of stacked semiconductor layers, and a laser beam is emitted from an end surface of the laser chip. The laser beam emitted from the laser chip has a certain divergence angle, and divergence degrees are different in different directions. The divergence angle parallel to a direction of a plane of the stacked structure of the laser chip is relatively large, and the divergence angle parallel to a stacking direction is relatively small, so that the laser beam emitted from the laser chip forms a spot pattern similar to an ellipse when entering a reflecting mirror f. A direction of a long axis of the ellipse corresponds to a direction of a larger divergence angle of the laser, which can be called a direction of a fast axis of the laser. A direction of a short axis of the ellipse corresponds to a direction of a smaller divergence angle of the laser, which can be called a direction of a slow axis of the laser. The reflecting mirror reflects a laser beam to a light emitting surface of the laser, and the laser beam is emitted after being collimated by a collimating lens. The collimating lens is generally designed for the divergence angle in the direction of the fast axis of the laser. Therefore, the divergence angle in the direction of the fast axis of the laser beam emitted after being collimated by the collimating lens t is smaller than the divergence angle in the direction of the slow axis. The long side of the laser shown in FIG. 3 is parallel to the first direction x. According to the above analysis, the direction of the fast axis of the laser beam emitted from the laser is parallel to the first direction x, and the direction of the slow axis is parallel to a second direction y.

As shown in FIG. 3 and FIG. 4, lasers are arranged along the first direction x, and the long sides of the lasers are parallel to the first direction x, so that the direction of the fast axis of the laser beam emitted from the laser is parallel to the first direction x. Therefore, light combination for the lasers is performed along the direction of the fast axis of the laser, so that a size of a combined light path along the first direction x is larger. Since the first assembly 121 and the second assembly 122 need to avoid an overlap in the third direction z, the size of the combined light path in the third direction z is larger, so that a volume of the combined light path is larger.

In view of this, embodiments of the present application provide a laser light source apparatus capable of combining light along the direction of the slow axis of the laser beam, and are favorable for reducing the volume of the combined light path.

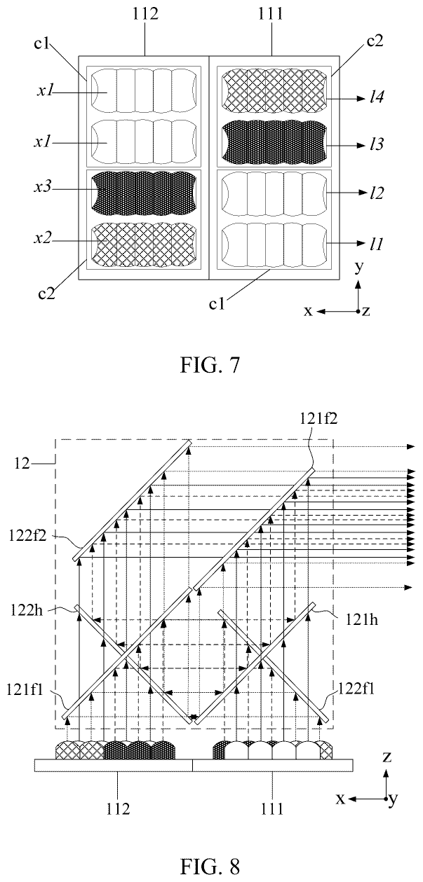

FIG. 6 is a first schematic diagram of an arrangement of lasers according to embodiments of the present application. FIG. 7 is a second schematic diagram of an arrangement of lasers according to embodiments of the present application.

The laser light source apparatus according to embodiments of the present application includes a light emitting assembly. The light emitting assembly includes at least two lasers, which are a first laser 111 and a second laser 112 respectively. The first laser 111 and the second laser 112 may be the laser shown in FIG. 1, or may be the laser shown in FIG. 2, or may be a laser of another arrangement.

The laser includes a light emitting device and a mounting substrate. The light emitting device includes a frame body, a cover plate and a collimating lens. A laser chip and a reflecting mirror are arranged in the frame body. The cover plate and the frame body are enclosed to form a closed space. A collimating lens is on the cover plate, and can be used for collimating a laser beam emitted. The mounting substrate includes a connection pattern and an electrical connection region, for mounting and electrically connecting the light emitting device. The frame body of the laser is rectangular as a whole and includes two first sides parallel to each other and two second sides parallel to each other. A length of the first side is greater than a length of the second side.

As shown in FIGS. 6 and 7, the first laser 111 and the second laser 112 are arranged along the first direction x. The second sides of the first laser 111 and the second laser 112 are parallel to the first direction x, and the first laser 111 and the second laser 112 are arranged in opposite directions along the second direction y. The first side of the first laser 111 and the first side of the second laser 112 are adjacent to each other. The first direction x and the second direction y are perpendicular to each other.

As can be seen from the above analysis, the direction of the long side (first side) of the laser is parallel to the direction of the fast axis of the laser beam emitted. The direction of the short side (second side) of the laser is parallel to the direction of the slow axis of the laser beam emitted. According to the above arrangement of the lasers, the slow axes of the laser beams emitted from the first laser 111 and the second laser 112 are parallel to the first direction x. The first laser 111 and the second laser 112 each include a plurality of laser chips. The laser chips are distributed in an array along the first direction x and the second direction y, to form a first light emitting region c1 and a second light emitting region c2 arranged along the second direction. A plurality of laser chips are arranged in both the first light emitting region c1 and the second light emitting region c2. The first light emitting region c1 of the first laser 111 and the second light emitting region c2 of the second laser 112 are aligned along the first direction x. The second light emitting region c2 of the first laser 111 and the first light emitting region c1 of the second laser 112 are aligned along the first direction x. It should be noted that numbers of laser chips in each of two rows in a laser may be the same or different. The first light emitting region c1 of the first laser 111 and the second light emitting region c2 of the second laser 112 are approximately centrally aligned along the first direction x. The second light emitting region c2 of the first laser 111 and the first light emitting region c1 of the second laser 112 are approximately centrally aligned along the first direction x.

For different kinds of lasers, numbers and arrangement rules of the laser chips arranged in the first light emitting region c1 and the second light emitting region c2 are different.

As shown in FIG. 6, the laser may include three types of laser chips arranged in two rows. The three types laser chips are a first laser chip x1, a second laser chip x2 and a third laser chip x3. The first laser chip x1 is in the first light emitting region c1, and the second laser chip x2 and the third laser chip x3 are in the second light emitting region. The first laser chips x1 in the first light emitting region c1 are arranged into a first laser chip row L1 along the first direction x. The second laser chip x2 and the third laser chip x3 in the second light emitting region c2 are arranged into a second laser chip row 12 along the first direction x. The first laser chip row L1 and the second laser chip row 12 are arranged in the second direction y.

As shown in FIG. 7, the laser may include three types of laser chips arranged in four rows. The three types of laser chips are a first laser chip x1, a second laser chip x2 and a third laser chip x3. The first laser chip x1 is in the first light emitting region c1, and the second laser chip x2 and the third laser chip x3 are in the second light emitting region. The first laser chips x1 in the first light emitting region c1 are arranged in two rows (11 and 12) along the first direction x. The third laser chips x3 in the second light emitting region c2 are arranged in a row along the first direction x (13). The second laser chips x2 in the second light emitting region c2 are arranged in a row along the first direction x. The four laser chip rows (11, 12, 13, and 14) are arranged in the second direction y.

Hereinafter, a combined light path in the laser light source apparatus will be described by taking the lasers shown in FIG. 6 as an example.

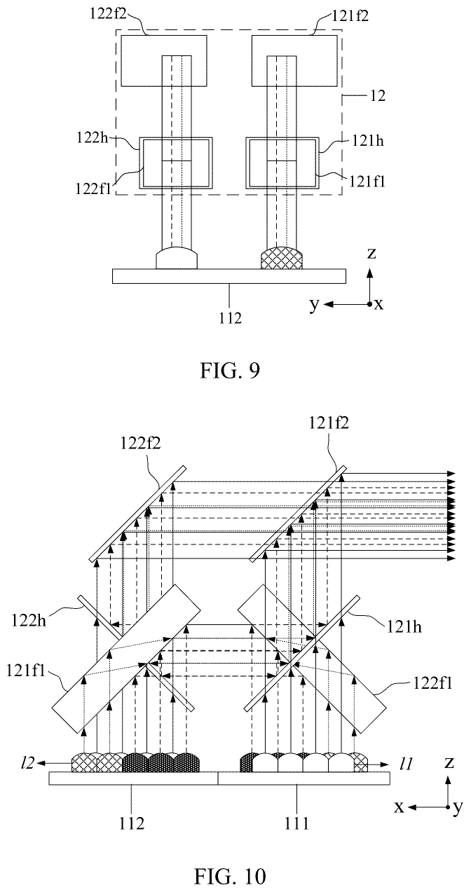

FIG. 8 is a first schematic structural diagram of a laser light source apparatus according to embodiments of the present application. FIG. 9 is a schematic side view of a laser light source apparatus shown in FIG. 8.

As shown in FIG. 8 and FIG. 9, the laser light source apparatus further includes a light combining assembly 12 at light emitting sides of the first laser 111 and the second laser 112. The light combining assembly 12 can combine a laser beam emitted from the first light emitting region c1 of the first laser 111 and a laser beam emitted from the second light emitting region c2 of the second laser 112, and combine a laser beam emitted from the second light emitting region c2 of the first laser 111 and a laser beam emitted from the first light emitting region c1 of the second laser 112, and emitting the laser beam combined along the first direction x, to realize combination of the laser beams along the direction of the slow axis of the laser.

By adopting the arrangement of the lasers according to embodiments of the present application and matching with the light combining assembly, laser beams emitted from different light emitting regions of the two lasers arranged along the first direction x can be combined along the direction of the slow axis of the laser, so that the laser beams emitted from the different light emitting regions are folded along the direction of the slow axis. Therefore, the size of the laser light source apparatus along the first direction can be reduced, to reduce the volume of the combined light path. Because the laser chips of different lasers have differences in divergence angle and wavelength, due to light combination for the first light emitting region of the first laser and the second light emitting region of the second laser, and light combination for the second light emitting region of the first laser and the first light emitting region of the second laser are combined, laser beams emitted from different lasers are combined, so that the divergence angle and the wavelength of the combined light beam can be diversified, to destroy strong coherence of the lasers, improving the homogenization effect.

In some embodiments, as shown in FIG. 8 and FIG. 9, the first laser 111 and the second laser 112 are arranged side by side, and light emitting directions of the first laser 111 and the second laser 112 are the same. The light combining assembly 12 includes a first assembly and a second assembly. The first assembly is at light emitting sides of the first light emitting region c1 of the first laser 111 and the second light emitting region c2 of the second laser 112. The second assembly is located at light emitting sides of the second light emitting region c2 of the first laser 111 and the first light emitting region c1 of the second laser 112. The first assembly is used for combining the laser beam emitted from the first light emitting region c1 of the first laser 111 and the laser beam emitted from the second light emitting region c2 of the second laser 112. The second assembly is used for combining the laser beam emitted from the second light emitting region c2 of the first laser 111 and the laser beam emitted from the first light emitting region c1 of the second laser 112.

In some embodiments, as shown in FIG. 8 and FIG. 9, the first assembly includes a first light reflecting piece 121f1, a first light combining piece 121h, and a second light reflecting piece 121f2. The first light reflecting piece 121f1 is at a light emitting side of the second light emitting region c2 of the second laser 112. The first light combining piece 121h is at a light emitting side of the first light emitting region c1 of the first laser 111. The second light reflecting piece 121f2 is at a light emitting side of the first light combining piece 121h. The first light reflecting piece 121f1, the first light combining piece 121h, and the second light reflecting piece 121f2 are arranged in parallel with each other, and are inclined at 45 degrees with respect to a plane of the laser.

As shown in FIG. 8, the first light reflecting piece 121f1 can receive the laser beam emitted from the second light emitting region c2 of the second laser 112 and reflect the laser beam received to the first light combining piece 121h. The first light combining piece 121h combines the laser beam emitted from the second light emitting region c2 of the second laser 112 and the laser beam emitted from the first light emitting region c1 of the first laser 111, and emits the laser beam combined to the second light reflecting piece 121f2. The second light reflecting piece 121f2 then reflects the laser beam combined and received along the first direction x, that is, emits the laser beam along the direction of the slow axis of the laser.

Similarly, the second assembly includes a third light reflecting piece 122f1, a second light combining piece 122h, and a fourth light reflecting piece 122f2. The third reflecting piece 122f1 is at a light emitting side of the second light emitting region c2 of the first laser 111. The second light combining piece 122h is at a light emitting side of the first light emitting region c1 of the second laser 112. The fourth light reflecting piece 122f2 is at a light emitting side of the second light combining piece 122h. The third light reflecting piece 122f1 and the second light combining piece 122h are arranged in parallel with each other, and the fourth light reflecting piece 122f2 and the second light reflecting piece 121f2 are arranged in parallel with each other. The third light reflecting piece 122f1, the second light combining piece 122h and the fourth light reflecting piece 122f2 are inclined at 45 degrees with respect to the plane of the laser. However, the fourth light reflecting piece 122f2 is inclined in an opposite direction to the third light reflecting piece 122f1 and the second light combining piece 122h.

As shown in FIG. 8, the third reflecting piece 122f1 can receive the laser beam emitted from the second light emitting region c2 of the first laser 111 and reflect the laser beam received to the second light combining piece 122h. The second light combining piece 122h combines the laser beam received and emitted from the second light emitting region c2 of the first laser 111 and the laser beam emitted from the first light emitting region c1 of the second laser 112, and emit the laser beam combined to the fourth reflecting piece 122f2. The fourth light reflecting piece 122f2 then emits the laser beam combined and received along the same direction as the light emitting direction of the first assembly.

As described above, the first laser chip is arranged in the first light emitting region c1, and the second laser chip and the third laser chip are arranged in the second light emitting region c2. The first laser chip may be a red laser chip, the second laser chip may be a green laser chip, and the third laser chip may be a blue laser chip. Therefore, the first light emitting region c1 can emit a red laser beam, and the second light emitting region c2 can emit s green laser beam and a blue laser beam. Then, the first light combining piece 121h and the second light combining piece 122h are used for combining the red laser beam with the green laser beam and the blue laser beam.

As shown in FIG. 8, the first light combining piece 121h and the second light combining piece 122h are both arranged at a light emitting side of the red laser chip to combine laser beams of three colors. Because the divergence angle of the red laser beam is larger than the divergence angle of the green laser beam and the divergence angle of the blue laser beam, and the divergence degree is larger when the light path of the laser is larger, the first light combining piece 121h and the second light combining piece 122h are arranged at a light emitting side of the red laser chip, to finally combine laser beams of three colors, so that the light path of the red laser is smaller than light paths of the green laser and the blue laser, and the divergence degree of the red laser after light combination is not too large, to reduce the difference in the divergence degree of the red laser, the green laser, and the blue laser.

In some embodiments, the first assembly and the second assembly may also be oppositely arranged. The first light combining piece 121h and the second light combining piece 122h are arranged at a light emitting side of the second light emitting region to combine laser beams of different colors. Thus, the laser beam combined is emitted in a direction opposite to a direction shown in FIG. 8.

In some embodiments, the first light combining piece 121h and the second light combining piece 122h may employ a dichroic film, a dichroic mirror, a polarization light combining film or a polarization light combining mirror, for transmitting a red laser beam and reflecting a green laser beam and a blue laser beam.

The dichroic film and the dichroic mirror can be formed into a thin film with a specific thickness by adopting a coating process and generally selecting a film material with a proper refractive index, so that the product of the refractive index and the thickness of the film layer can achieve the effect of enhanced transmission or enhanced reflection on light with a specific wavelength. For the laser with the above structure, the dichroic film or the dichroic mirror can increase transmission of the red laser light, and increase reflection of the green laser light and the blue laser light.

The polarization light combining film or the polarization light combining mirror can transmit light in a first polarization direction and reflect light in a second polarization direction. The first polarization direction and the second polarization direction are perpendicular to each other. The laser light emitted from the laser is polarized light, and different laser chips can emit polarized light with different polarization directions. When the laser can emit first polarized light and second polarized light, a polarization light combining film or a polarization light combining mirror may be used to combine light.

In some embodiments, the laser beam emitted from the first laser chip (red laser chip) is first polarized light. The laser beam emitted from the second laser chip (green laser chip) and the third laser chip (blue laser chip) is second polarized light. Therefore, the polarization light combining film or the polarization light combining mirror can combine laser beams emitted from the three laser chips.

The first polarized light may be P-polarized light, and the second polarized light may be S-polarized light. The polarization direction of the P-polarized light is parallel to an incident plane, and the polarization direction of the S-polarized light is perpendicular to the incident plane. Generally, the red laser light emitted from the red laser chip can be P-polarized light. The green laser light emitted from the green laser chip may be S-polarized light, and the blue laser light emitted from the blue laser chip may be S-polarized light.

The second light reflecting piece 121f2 and the fourth light reflecting piece 122f2 may use a reflecting film or a reflecting mirror. The first light reflecting piece 121f1 and the third light reflecting piece 122f1 may use a reflecting film or a reflecting mirror.

In some embodiments, inclination directions of the second light reflecting piece 121f2 and the fourth light reflecting piece 122f2 in FIG. 8 are changed, so that the second light reflecting piece 121f2 and the fourth light reflecting piece 122f2 are obliquely arranged in the second direction y with respect to the plane of the laser. Therefore, the second light reflecting piece 121f2 and the fourth reflecting piece 122f2 may emit the laser beam combined along the second direction y.

In some embodiments, specific devices included in the first assembly and second assembly, and positions and inclination directions of the specific devices in the first assembly and second assembly are changed, so that the laser beam combined for the first laser 111 and the second laser 112 may be emitted along the third direction z. For example, the first assembly includes a first light reflecting piece and a first light combining piece. The first light reflecting piece reflects the laser beam emitted from the second light emitting region of the second laser to the first light combining piece. The first light combining piece combines the laser beam emitted from the second light emitting region of the second laser and the laser beam emitted from the first light emitting region of the first laser, and emits the laser beam combined directly along the third direction z. The second assembly includes a second light reflecting piece and a second light combining piece. The second light reflecting piece reflects the laser beam emitted from the first light emitting region of the second laser to the second light combining piece. The second light combining piece combines the laser beam emitted from the first light emitting region of the second laser and the laser beam emitted from the second light emitting region of the first laser, and emits the laser beam combined directly along the third direction z.

As can be seen, specific devices included in the light combining assembly, and arranging positions and inclination directions of the specific devices in the light combining assembly can be adjusted according to a light emitting direction required by the laser light source apparatus. Embodiments of the present application do not limit the specific structure of the light combining assembly.

In some embodiments, each of the first light reflecting piece 121f1 and the third light reflecting piece 122f1 may be a transparent flat plate. The function of reflecting light is realized by coating a film on a surface of the transparent flat plate. Meanwhile, by reasonably selecting a material and a thickness of the transparent flat plate, transfer of the light spot position can also be realized by using the coating film, so that distribution of combined light spots is symmetrical, and the homogenization effect is improved.

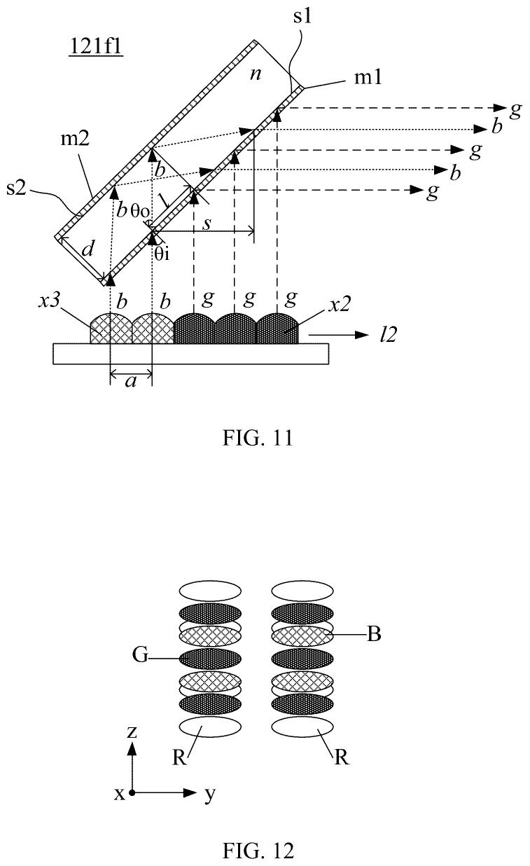

FIG. 10 is a second schematic structural diagram of a laser light source apparatus according to embodiments of the present application. FIG. 11 is a schematic diagram of a principle of a light path of a transparent flat plate according to embodiments of the present application. FIG. 12 is a schematic diagram of a combined light spot of a combined light path shown in FIG. 10.

For the laser shown in FIG. 6, the third laser chips x3 and the second laser chips x2 are located in the second laser chip row 12. The number of the third laser chips x3 is two, and the number of the second laser chips x2 is three. Because the number of the third laser chips x3 and the number of the second laser chips x2 are different, and the third laser chips x3 and the second laser chips x2 are arranged in a concentrated manner, the second laser chip row 12 may emit laser beams of two colors. As a result, the color distribution of the combined light spot after being combined with the laser beam emitted from the first laser chip x1 is not uniform.

In order to address the above problems, as shown in FIGS. 10 and 11, each of the first light reflecting piece 121f1 and the third light reflecting piece 122f1 may be a transparent flat plate. The transparent flat plate includes a first surface s1 and a second surface s2 parallel to each other. The first surface s1 is arranged facing the second laser chip row 12, and the second surface s2 is arranged facing away from the second laser chip row 12. The first surface s1 is provided with a first film layer m1. The first film layer m1 is used for transmitting a laser beam emitted from the third laser chip x3, and reflecting a laser beam emitted from the second laser chip x2. The second surface s2 is provided with a second film layer m2, and the second film layer m2 is used for reflecting incident light.

In some embodiments, the first laser chip is a red laser chip, the second laser chip is a green laser chip, and the third laser chip is a blue laser chip. As shown in FIG. 11, when the blue laser beam b emitted from the blue laser chip (third laser chip x3) in the second laser chip row and the green laser beam g emitted from the green laser chip (second laser chip x2) in the second laser chip row are incident on the first surface s1 of the transparent flat plate, the green laser beam g is reflected by the first film layer m1, and the blue laser beam is incident to the inside of the transparent flat plate. Through manufacturing the transparent flat plate by selecting reasonable materials, and setting the thickness of the transparent flat plate, the blue laser beam b incident into the transparent flat plate can be emitted from the first surface s1 after being reflected by the second film layer m2 on the second surface s2. The emergent blue laser beam b is emitted from a gap between green laser beams g. The arrangement of the light spots after light combination is as shown in FIG. 12, in which green light spots G and blue light spots B are alternately arranged. The color distribution of the light spot after light combination is symmetrical, which is more beneficial to the subsequent light homogenization.

As shown in FIG. 11, the blue laser beam is refracted when the blue laser beam is incident on the transparent flat plate from the air, and the refraction law is satisfied:

$$sin θ i = n \times sin θ o .$$

Where θi is an angle of incidence, θo is an angle of refraction, and n is a refractive index of the transparent flat plate.

In order to make emitting directions of combined beams the same, in general, each assembly in the light combining assembly is placed at an angle of 45° to the plane where the laser is located. Incident angles of the blue laser beam b and the green laser beam g incident on the first surface s1 of the transparent flat plate are both 45°, that is, θi=45°.

From this it can be calculated that:

$$sin θ o = \frac{\sqrt{2}}{2 n} .$$

According to the trigonometric function relationship, following formulas can also be obtained:

$$tan θ o = \frac{sin θ o}{cos θ o} = \frac{sin θ o}{\sqrt{1 - {sin}^{2} θ o}} = \frac{\sqrt{2}}{\sqrt{4 {n}^{2} - 2}} ;$$

$$s = 2 l \times sin 45 ° = 2 d \times tan θ o \times sin 45 ° = \frac{2 d \sqrt{2}}{\sqrt{4 {n}^{2} - 2}} = \frac{d}{\sqrt{{n}^{2} - \frac{1}{2}}} .$$

Where s represents a distance that the blue laser beam moves after passing through the transparent flat plate, and d represents a thickness of the transparent flat plate.

If a distance between two adjacent laser beams emitted from a laser is a, then a limit position of movement of the blue laser beam is not beyond an edge of the green laser beam, and the best movement position is in the middle of the green laser. Accordingly, s needs to satisfy:

$$2 a \leq s \leq 3 a .$$

Therefore, the refractive index and thickness of the transparent flat plate satisfy:

$$2 a \leq \frac{d}{\sqrt{{n}^{2} - \frac{1}{2}}} \leq 3 a .$$

Suppose a=1 mm, the above formula can be changed to be 4n²−2≤d²≤9n²−4.5.

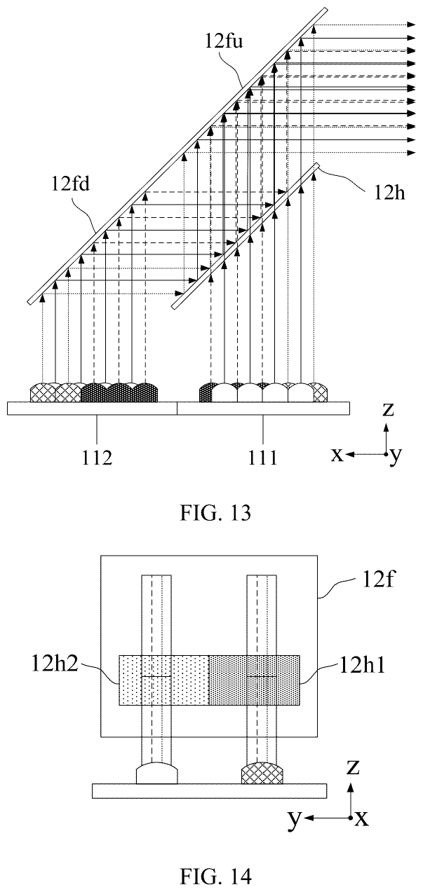

FIG. 13 is a third schematic structural diagram of a laser light source apparatus according to embodiments of the present application. FIG. 14 is a schematic side view of a laser light source apparatus shown in FIG. 13.

In some embodiments, as shown in FIG. 13 and FIG. 14, the first laser 111 and the second laser 112 are arranged side by side, and the light emitting directions of the first laser 111 and the second laser 112 are the same. The light combining assembly includes a light reflecting piece 12f and a light combining piece 12h. The light reflecting piece 12f is at a light emitting side of the first laser 111 and the second laser 112. The light combining piece 12h is between the light reflecting piece 12f and the first laser 111. The light reflecting piece 12f and the light combining piece 12h are parallel to each other, and are obliquely arranged relative to the plane of the laser.

A width of the light reflecting piece 12f along the first direction x is greater than a width of the light combining piece 12h along the first direction. The light reflecting piece 12f is divided into an upper part 12fu and a lower part 12fd. The upper part 12fu of the light reflecting piece is arranged correspondingly to the first laser 111. The lower part 12fd of the light reflecting piece is arranged correspondingly to the second laser 112. The light combining piece 12h is divided into a first part 12h1 and a second part 12h2. The first part 12h1 of the light combining piece is arranged correspondingly to the first light emitting region c1 of the first laser 111. The second part 12h2 of the light combining piece is arranged correspondingly to the second light emitting region c2 of the first laser 111.

As shown in FIG. 13, the lower part 12fd of the light reflecting piece receives the laser beam emitted from the second light emitting region of the second laser 112 and reflects the laser beam to the first part 12h1 of the light combining piece. The lower part 12fd of the light reflecting piece also receives the laser beam emitted from the first light emitting region of the second laser 112 and reflects the laser beam to the second part 12h2 of the light combining piece. The first part 12h1 of the light combining piece combines the received laser beam emitted from the second light emitting region of the second laser 112 and the laser beam emitted from the first light emitting region of the first laser 111, and emits the laser beam combined to the upper part 12fu of the first reflecting piece. The second part 12h2 of the light combining piece combines the received laser beam emitted from the first light emitting region of the second laser 112 and the laser beam emitted from the second light emitting region of the first laser 111, and emits the laser beam combined to the upper part 12fu of the light reflecting piece. The upper part 12fu of the light reflecting piece reflects the received and combined laser beam along the first direction x, and combines the laser beam along the direction of the slow axis of the laser.

In some embodiments, the first light emitting region may emit a red laser beam, the second light emitting region may emit a green laser beam and a blue laser beam. The light reflecting piece 12f may employ a reflecting film or a reflecting mirror for reflecting light with the full wavelength band. The upper part and lower part of the light reflecting piece 12f may also be provided in two parts. Dichroic film or dichroic mirror can be used for the light combining piece 12h, and the number of assemblies can be reduced by means of zonal coating. Of course, the first part and the second part of the light combining piece may also be respectively arranged into two light combining parts corresponding to the first light emitting region and the second light emitting region of the first laser. The first part 12h1 of the light combining piece is used for transmitting the red laser beam and reflect the green laser beam and the blue laser beam. The second part 12h2 of the light combining piece is used for transmitting the green laser light and the blue laser light, and reflects the red laser beam.

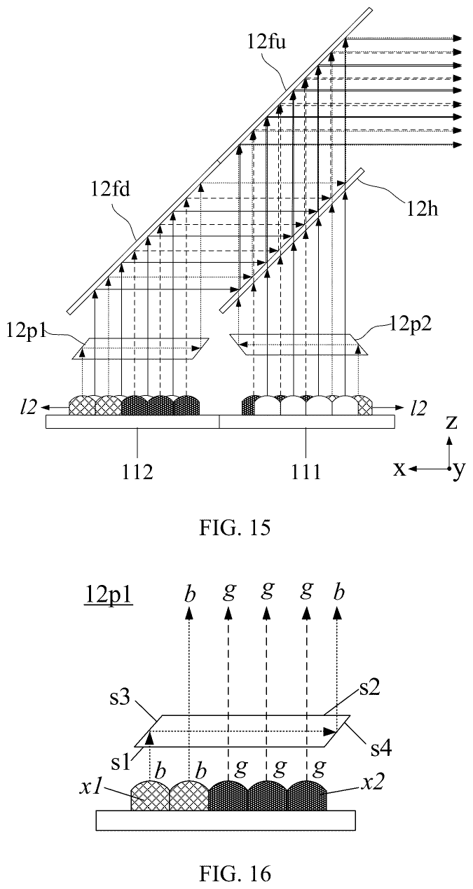

FIG. 15 is a fourth schematic structural diagram of a laser light source apparatus according to embodiments of the present application. FIG. 16 is a schematic diagram of a principle of a light path of a prism according to embodiments of the present application.

In order to address asymmetry of the distribution of the blue laser light spot and the green laser light spot in the combined light spot, leading to the problem of poor uniformity of the combined light spot, as shown in FIG. 15, the laser light source apparatus is further provided with a first prism 12p1 and a second prism 12p2. The first prism 12p1 may be located only at a light emitting side of the second laser chip row 12 of the second laser 112, and may also be arranged at a light emitting side of the second laser 112. The second prism 12p2 may be only located at a light emitting side of the second laser chip row 12 of the first laser 111, and may also be arranged at a light emitting side of the first laser 111.

When the second laser chip row is constituted by an arrangement of blue laser chips and green laser chips, and the first prism 12p1 and the second prism 12p2 are arranged only at the light emitting side of the second laser chip row, the first prism 12p1 and the second prism 12p2 may transfer a part of the blue laser beam to a side of the green laser beam away from the blue laser beam for emitting, so that emitted blue light spots and emitted green light spots are uniformly distributed.

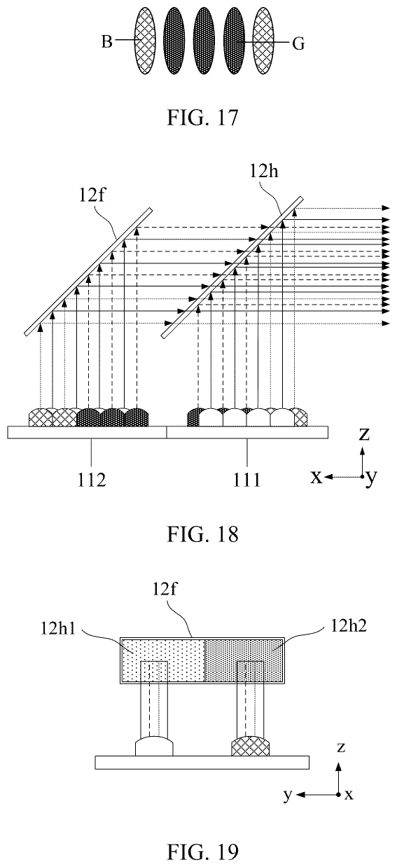

As shown in FIG. 16, the first prism 12p1 and the second prism 12p2 include a first surface s1 and a second surface s2 facing the second laser chip row and arranged in parallel, and further includes a third surface s3 and a fourth surface s4 on both sides of the first surface s1 and the second surface s2. As shown in FIG. 16, the first surface s1 and the second surface s2 are perpendicular to incident laser light. The third surface s3 and the fourth surface s4 are obliquely arranged with respect to the incident laser light. A green laser beam g emitted from the green laser chip (the second laser chip x2) and a blue laser beam b emitted from the blue laser chip (the third laser chip x3) may be normally incident on the first surface s1 without changing direction inside the incident prism. The blue laser beam b and the green laser beam g are directly emitted from the second surface s2. After a blue laser beam b emitted from the blue laser chip (the third laser chip x3) located at the edge is incident on the first surface s1, the blue laser beam b may be incident on the third surface s3 inside the prism. Since the third surface s3 is obliquely arranged, the blue laser beam is reflected by the third surface s3 and propagates inside the prism to be incident on the fourth surface s4, and is reflected by the fourth surface s4 to be emitted from the second surface s2. Therefore, the blue laser beam b emitted from the blue laser chip at the edge can be transferred to the other side of the green laser chip for emitting. As shown in FIG. 17, the blue light spots B are respectively at two sides of the green light spots G. The color distribution of the emitted light spots must be symmetrical.

By arranging the prism on the light emitting side of the second laser chip row 12, the blue light spots can be respectively at two sides of the green light spots. The spatial overlap of the blue light spot and the green light spot is increased, and the light spot boundary is weakened. For combined light spots of three colors, overlapping degrees of the red light spot, the green light spot and the blue light spot are also increased. The phenomenon of partial color cast of the light spot is weakened, so that the uniformity and symmetry of the color distribution of the combined light spots are improved.

FIG. 18 is a fifth schematic structural diagram of a laser light source apparatus according to embodiments of the present application. FIG. 19 is a schematic side view of a laser light source apparatus shown in FIG. 18.

In some embodiments, as shown in FIG. 18 and FIG. 19, the first laser 111 and the second laser 112 are arranged side by side, and light emitting directions of the first laser 111 and the second laser 112 are the same. The light combining assembly includes a light reflecting piece 12f and a light combining piece 12h. The light reflecting piece 12f is at a light emitting side of the second laser 112, and the light combining piece 12h is at a light emitting side of the first laser 111. The light reflecting piece 12f and the light combining piece 12h are arranged in parallel with each other.

As shown in FIG. 19, the light combining piece 12h is divided into a first part 12h1 and a second part 12h2. The first part 12h1 of the light combining piece is arranged correspondingly to the first light emitting region of the first laser 111. The second part 12h2 of the light combining piece is arranged correspondingly to the second light emitting region of the first laser 111.

As shown in FIG. 18, the light reflecting piece 12f receives the laser beam emitted from the second light emitting region of the second laser 112 and reflects the laser beam to the first part 12h1 of the light combining piece, receives the laser beam emitted from the first light emitting region of the second laser 112 and reflects the laser beam to the second part 12h2 of the light combining piece. The first part 12h1 of the light combining piece combines the received laser beam emitted from the second light emitting region of the second laser 112 and the laser beam emitted from the first light emitting region of the first laser 111, the second part 12h2 of the light combining piece combines the received laser beam emitted from the first light emitting region of the second laser 112 and the laser beam emitted from the second light emitting region of the first laser 111, and finally the first part 12h1 and the second part 12h2 of the light combining piece emit the laser beam combined along the first direction x, and combine laser beams along the direction of the slow axis of the laser beam.

The light reflecting piece 12f may employ a reflecting film or a reflecting mirror, for reflecting light with the full wavelength band. The light reflecting piece 12f may be provided corresponding to the first light emitting region and the second light emitting region of the second laser respectively. Dichroic film or dichroic mirror can be used for the light combining piece 12h, and the number of assemblies used can be reduced by means of zonal coating. Of course, the first part and the second part of the light combining piece may also be respectively arranged into two light combining parts corresponding to the first light emitting region and the second light emitting region of the first laser. The first light emitting region can emit the red laser beam, the second light emitting region can emit the green laser beam and the blue laser beam. Then the first part 12h1 of the light combining piece is used for transmitting the green laser beam and the blue laser beam, and reflect the red laser beam. The second part 12h2 of the light combining piece is used for transmitting the red laser beam and reflects the green laser beam and the blue laser beam.

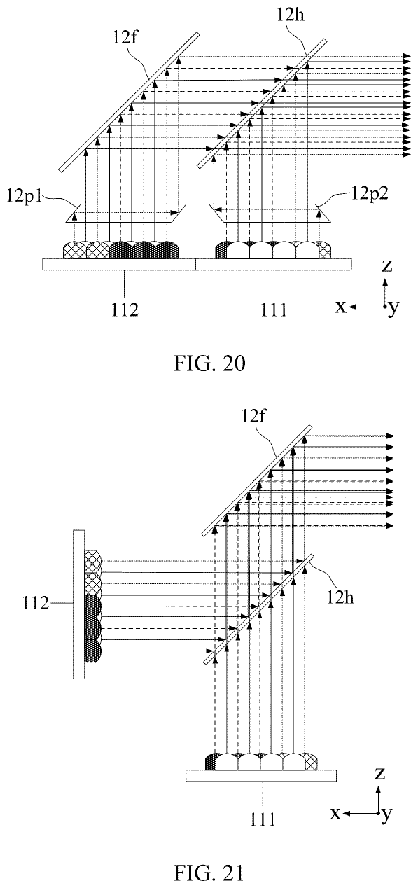

FIG. 20 is a sixth schematic structural diagram of a laser light source apparatus according to embodiments of the present application.

Similarly, in order to address the problem of non-uniform color distribution of the combined light spot, as shown in FIG. 20, the laser light source apparatus is further provided with a first prism 12p1 and a second prism 12p2. Positions, functions, and principles of the first prism 12p1 and the second prism 12p2 can be referred to the above embodiments, and are not described here.

FIG. 21 is a seventh schematic structural diagram of a laser light source apparatus according to embodiments of the present application.

In some embodiments, as shown in FIG. 21, the first laser 111 and the second laser 112 are arranged perpendicularly, and light emitting directions of the first laser 111 and the second laser 112 are perpendicular to each other. The light combining assembly includes a light reflecting piece 12f and a light combining piece 12h. The light combining piece 12h is located at an intersection of the laser beam emitted from the first laser 111 and the laser beam emitted from the second laser 112. The light reflecting piece 12f is located at a side of the light combining piece 12h facing away from the first laser 111. The light combining piece is divided into a first part and a second part. The first part of the light combining piece is arranged correspondingly to the first light emitting region of the first laser 111 and the second light emitting region of the second laser 112. The second part of the light combining piece is arranged correspondingly to the second light emitting region of the first laser 111 and the first light emitting region of the second laser 112. The first part of the light combining piece is used for receiving the laser beam emitted from the first light emitting region of the first laser 111 and the laser beam emitted from the second light emitting region of the second laser 112, combining the laser beams received, and emitting the laser beam combined to the light reflecting piece 12f. The second part of the light combining piece is used for receiving the laser beam emitted from the second light emitting region of the first laser 111 and the laser beam emitted from the first light emitting region of the second laser 112, combining the laser beams received, and emitting the laser beam combined to the light reflecting piece 12f. The light reflecting piece 12f is used for receiving the combined laser beam, reflecting the combined laser beam along the first direction x, and combining laser beams along the direction of the slow axis of the laser.

The light reflecting piece 12f may employ a reflecting film or a reflecting mirror, for reflecting light with the full wavelength band. The light reflecting piece 12f may be provided in two parts corresponding to the first light emitting region and the second light emitting region of the laser. Dichroic film or dichroic mirror can be used for the light combining piece 12h, and the number of assemblies can be reduced by means of zonal coating. Of course, the first part and the second part of the light combining piece may also be respectively arranged into two light combining parts corresponding to the first light emitting region and the second light emitting region of the laser. The first light emitting region can emit the red laser beam, the second light emitting region can emit the green laser beam and the blue laser beam. Then the first part of the light combining piece is used for transmitting the red laser beam and reflecting the green laser beam and the blue laser beam. The second part of the light combining piece is used for transmitting the green laser beam and the blue laser beam and reflecting the red laser beam.

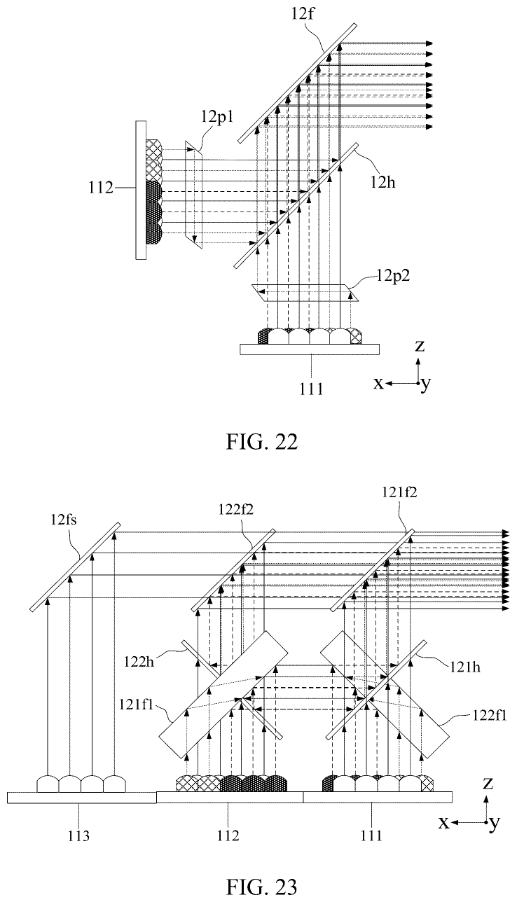

FIG. 22 is an eighth schematic structural diagram of a laser light source apparatus according to embodiments of the present application.

Similarly, in order to address the problem of non-uniform color distribution of the combined light spot, as shown in FIG. 22, the laser light source apparatus is further provided with a first prism 12p1 and a second prism 12p2. Positions, functions, and principles of the first prism 12p1 and the second prism 12p2 can be referred to the above embodiments, and are not described here.

In some embodiments, the first laser 111 and the second laser 112 may also be oppositely arranged. The first laser 111 can be turned to emit light downward on the basis of the setting position of the first laser 111 shown in FIG. 8, so that light emitting directions of the first laser 111 and the second laser 112 are opposite. The light combining assembly may be located between the first laser 111 and the second laser 112. The light combining assembly can include a light reflecting piece and a light combining piece. The light combining piece includes a first part and a second part. The light reflecting piece can be arranged at a light emitting side of the second laser, and the light combining piece can be arranged at a light emitting side of the first laser. Inclination directions of the light reflecting piece and the light combining piece are opposite. The light reflecting piece reflects the laser beam emitted from the second laser to the light combining piece. The first part of the light combining piece can combine the laser beam emitted from the second light emitting region of the second laser and the laser beam emitted from the first light emitting region of the first laser. The second part of the light combining piece can combine the laser beam emitted from the first light emitting region of the second laser and the laser beam emitted from the second light emitting region of the first laser, and emit the laser beam combined along the first direction.

Similarly, prisms can also be arranged in second light emitting regions of the first laser and the second laser to change emitting positions of laser beams, to achieve the effect of symmetrical laser spot color.

In embodiments of the present application, according to a specific application scenario, the first laser and the second laser may be arranged side by side or perpendicularly, or may be arranged oppositely and in a staggered manner in the light emitting regions. The light combining assembly needs to adopt different specific pieces to combine laser beams according to setting directions of the lasers. Embodiments of the present application do not limit setting of the lasers, the specific structure of the light combining assembly, and the final light emitting direction.

It should be noted that in the above embodiments, the laser light source apparatus using the lasers shown in FIG. 6 is taken as an example. In a specific implementation, the above combined light path is also applicable to the lasers as shown in FIG. 7. The difference is that, because positions of laser beams emitted from the second laser chip and the third laser chip do not need to be adjusted for the lasers shown in FIG. 7, use of transparent flat plates and prisms is not required.

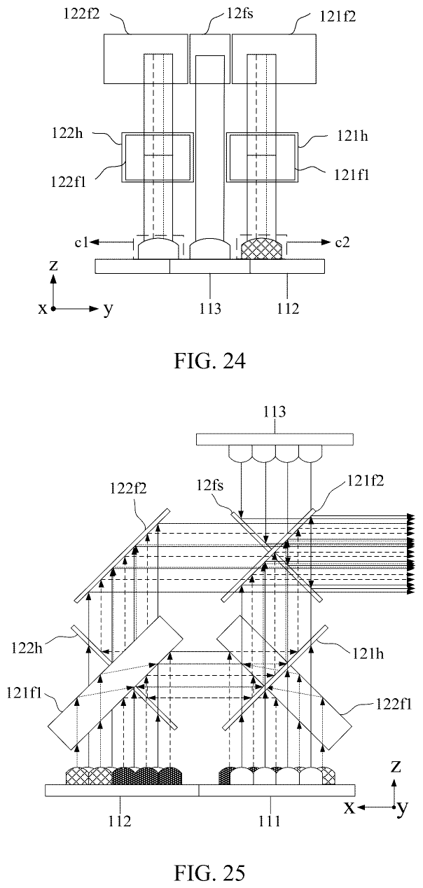

FIG. 23 is a ninth schematic structural diagram of a laser light source apparatus according to embodiments of the present application. FIG. 24 is a schematic side view of a laser light source apparatus shown in FIG. 23.

In some embodiments, as shown in FIGS. 23 and 24, the laser light source apparatus further includes a third laser 113. Because the whole luminous flux and the color ratio of the laser light source apparatus are limited by color ratios of lasers, in practical applications, a monochromatic laser can be added to increase the whole luminous flux or improve brightness and proportion of a certain color. The third laser 113 may a monochromatic laser. If the first laser and the second laser can emit red laser light, green laser light, and blue laser light, the third laser 113 may emit at least one of red laser light, green laser light, and blue laser light as needed.

In order to combine the monochromatic laser beam emitted from the third laser 113 with laser beams emitted from the first laser 111 and the second laser 112, the laser light source apparatus further includes a reflector 12fs at a light emitting side of the third laser 113. The reflector 12fs is used for receiving the laser beam emitted from the third laser 113 and reflecting the laser beam received along the same direction as emitting directions of the combined laser beams of the first laser and the second laser.

In some embodiments, as shown in FIG. 23, the first laser 111 and the second laser 112 are arranged side by side, and the light emitting directions of the first laser 111 and the second laser 112 are the same. The third laser 113 may be arranged adjacent to the second laser 112, and the third laser 113 and the second laser 112 are arranged side by side. A light emitting direction of the third laser 113 is the same as light emitting directions of the first laser 111 and the second laser 112.

As shown in FIG. 24, assuming that the first laser 111 and the second laser 112 adopt the combined light path shown in FIG. 10, a position of the reflector 12fs may correspond to a position between the second light reflecting piece 121f2 and the fourth light reflecting piece 122f2, so that a laser light spot emitted from the third laser 113 is between combined light spots of the first laser 111 and the second laser 112.

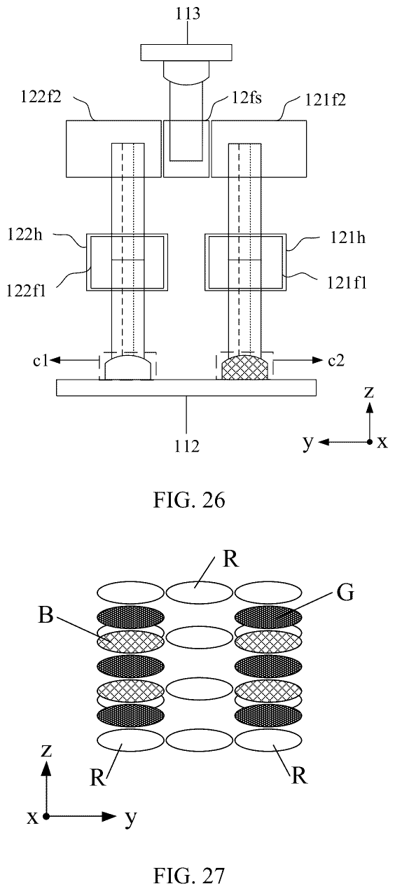

FIG. 25 is a tenth schematic structural diagram of a laser light source apparatus according to embodiments of the present application. FIG. 26 is a schematic diagram of a side view structure of a laser light source apparatus shown in FIG. 25. FIG. 27 is a schematic diagram of a combined light spot according to embodiments of the present application.

In some embodiments, as shown in FIG. 25, the first laser 111 and the second laser 112 are arranged side by side, and light emitting directions of the first laser 111 and the second laser 112 are the same. The third laser 113 may be arranged opposite to the first laser 111. A light emitting direction of the third laser 113 is opposite to a light emitting direction of the first laser 111.

Accordingly, as shown in FIG. 26, the third laser 113, the first laser 111, and the second laser 112 need to be placed in a staggered manner, so that the position of the reflector 12fs corresponds to a position between the second light reflecting piece 121f2 and the fourth light reflecting piece 122f2, and the laser spot emitted from the third laser 113 is between the combined light spots of the first laser 111 and the second laser 112. The combined light spots can be seen in FIG. 27.

As can be seen from FIG. 24 and FIG. 26, the third laser 113 needs to be arranged at a position between the first laser 111 and the second laser 112. Accordingly, an orthographic projection of the reflector 12fs on the plane where the first laser 111 and the second laser 112 are located is between the first light emitting region c1 and the second light emitting region c2 of the laser, so that the laser spot emitted from the third laser 113 is located in the middle of the combined light spot. A size of the combined light spot is not increased.

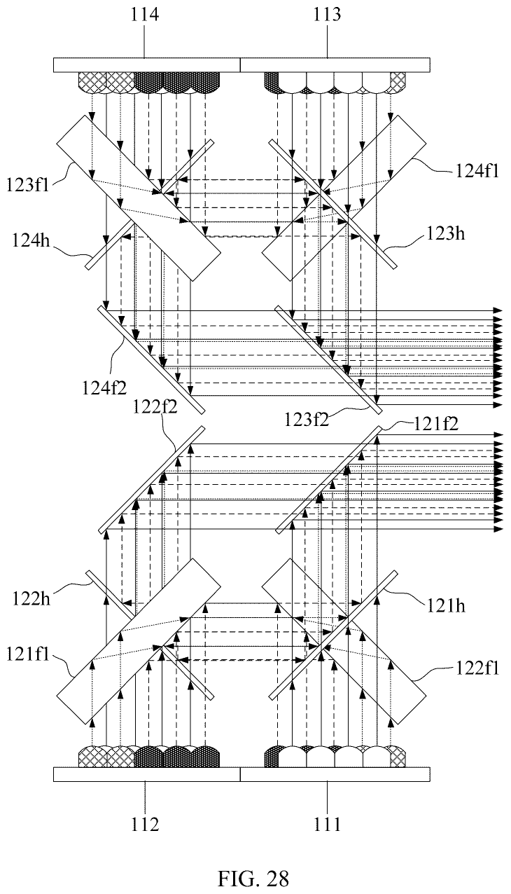

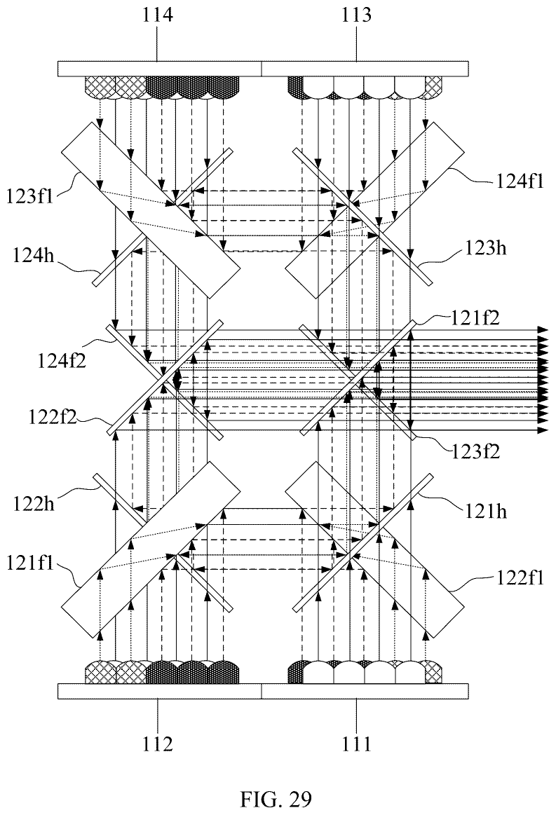

FIG. 28 is an eleventh structural diagram of a laser light source apparatus according to embodiments of the present application. FIG. 29 is a twelfth structural diagram of a laser light source apparatus according to embodiments of the present application.

In some embodiments, as shown in FIGS. 28 and 29, the laser light source apparatus may include four lasers. The four lasers may be of the same laser type. Still taking the first laser 111 and the second laser 112 adopting the light path structure shown in FIG. 10 as an example, the third laser 113 and the fourth laser 114 may be arranged opposite to the first laser 111 and the second laser 112. The combined light path of the third laser 113 and the fourth laser 114 may be the same as the combined light path of the first laser 111 and the second laser 112, so that the combined light path of two lasers can be modularized, and the number of modules can be increased as required.

As shown in FIG. 28, the combined light path of the third laser 113 and the fourth laser 114 may be arranged symmetrically with the combined light path of the first laser 111 and the second laser 112. Alternatively, as shown in FIG. 29, the third laser 113 and the fourth laser 114 can be arranged in a staggered manner relative to the first laser 111 and the second laser 112, so that the combined light path of the third and fourth lasers 114 and the combined light path of the first and second lasers 112 can be made to coincide with each other, to not only avoid mutual interference of the combined light paths on positions, but also compress the volume of the laser light source apparatus.

Taking the combined light path shown in FIG. 10 is as an example, embodiments of the present application illustrate a variant structure of the laser light source apparatus by adding one or two lasers on the basis of the laser light source apparatus. In a specific implementation, a laser and a combined light path of the laser can also be added on the basis of the combined light path shown in FIGS. 13, 15, 18, 20, 21, and 22, as long as the principle that no position interference exists between light combining elements and the size of the combined light spot is as small as possible is met. Variant structures of corresponding laser light sources are not listed here, and structures of related laser light sources belong to the protection scope of the present application.

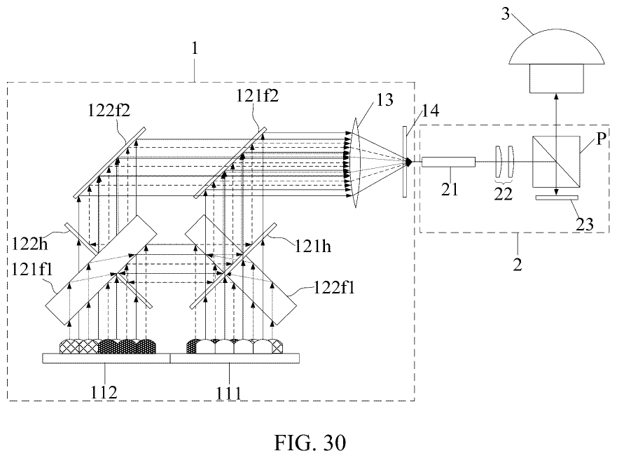

Based on the same inventive concept, embodiments of the present application further provide a projection system. FIG. 30 is a schematic structural diagram of a projection system according to embodiments of the present application. As shown in FIG. 30, the projection system includes a laser light source apparatus 1, an illumination system 2, and a projection lens 3.

The laser light source apparatus 1 may user any of the above laser light source apparatuses. The illumination system 2 is at a light emitting side of the laser light source apparatus 1, and is used for shaping and homogenizing the laser beam emitted from the laser light source apparatus 1. As shown in FIG. 30, the illumination system 2 includes a light homogenizing element 21, a shaping lens 22, and a light modulator 23.

The light homogenizing element 21 may use a light pipe shown in FIG. 30, or may use a light homogenizing element such as a fly-eye lens. When the light homogenizing element 21 uses the fly-eye lens, the laser light source apparatus can achieve a better homogenization effect without mandatory requirements on symmetry of the light spot. The shaping lens 22 can adjust a shape and size of a laser light spot incident on the light modulator 23, so that the laser beam is incident on the light modulator 23 at an appropriate angle.

The light modulator 23 is used for modulating incident light to form an image. In a specific implementation, the light modulator 23 may be a transmission-type light modulator or a reflection-type light modulator. The light modulator 23 shown in FIG. 30 is a reflection-type light modulator. The light modulator 23 receives light reflected by a dichroic prism P, modulates incident light, and reflects modulated light. Since the light path is folded back by the reflection-type light modulator, a volume of the projection system can be reduced.

In embodiments of the present application, the light modulator 23 may use Liquid Crystal on Silicon (LCoS) or Digital Micromirror Device (DMD).

LCOS is encapsulated by attaching a Complementary Metal Oxide Semiconductor (CMOS) substrate to a glass substrate containing a transparent electrode based on a semiconductor technology, and then injecting liquid crystal. LCOS has characteristics of high aperture ratio of each pixel and high resolution, which can form high-resolution images.

The DMD includes a plurality of micro reflecting mirrors. Each of the micro reflecting mirrors can be driven to deflect independently. By controlling a deflection angle of the DMD, brightness of light incident on the projection lens 3 is controlled.

The dichroic prism P is used for separating an illumination beam and an imaging beam. The laser beam emitted from the laser light source apparatus 1 is finally reflected to the light modulator 23 by the dichroic prism P through shaping and homogenization. Light modulated by the light modulator 23 is incident on the projection lens 3 through the dichroic prism P.

After the light modulator 23 modulates the incident light to form an image, the light is reflected to the projection lens 3. The image is formed by the projection lens 3 so that the image is projected to a suitable size for viewing.

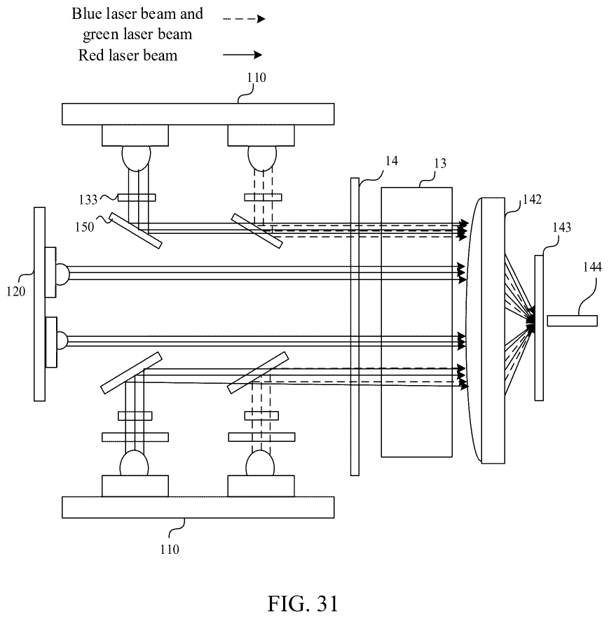

In some embodiments, as shown in FIG. 31, in order to ensure display brightness of a projected image, based on the laser design limit, the current three-primary color ratios mainly depend on laser chips, so it is necessary to add a laser with a certain color ratio, and a monochromatic laser needs to be added. The laser light source apparatus can include a three-color laser, a monochromatic laser, a light combining assembly and a light homogenizing element. A prism is used for ensuring that light spots of the three-color laser and the monochromatic laser are uniformly distributed. Light beams are combined through a reflecting sheet. In order to ensure the required light spot homogenization, it is necessary to add a group of lenses 13 behind the diffusion sheet 14, for example, add a group of beam contraction lenses or beam expansion lenses. The uniform distribution of incident light spots is realized through the group of lenses. The light homogenizing element can homogenize the laser beam from the light combining assembly and guide the laser beam to the illumination system. Since the reflecting sheet 150 is used for light combination, and the lens 13 is added to ensure the uniformity of the light spot, the volume of the laser light source is increased, and the experience is poor.

In order to address the above problem, the present application provides a laser light source apparatus. Polarization directions of a first laser beam in a first laser and a second laser beam in a second laser with the same wavelength and the same polarization direction as the first laser beam are changed by a polarization adjusting element, so that the first laser beam and the second laser beam are laser beams with the same wavelength and different polarization directions, then the first laser beam and the second laser beam with different polarization directions are combined through a polarization light combining sheet, and the combined laser beam is guided to the light homogenizing element. When polarization directions of laser beams are different, the speckle problem of the laser can be alleviated. In addition, the added second laser can add a certain color to the whole laser light source apparatus, to increase brightness of the laser light source apparatus. Meanwhile, this design can reduce the number of lenses, to reduce the manufacturing cost of the laser light source apparatus, and accordingly reduce the volume of the laser light source apparatus.

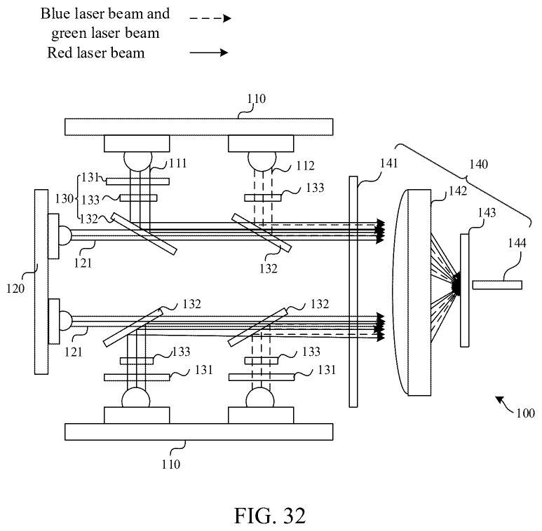

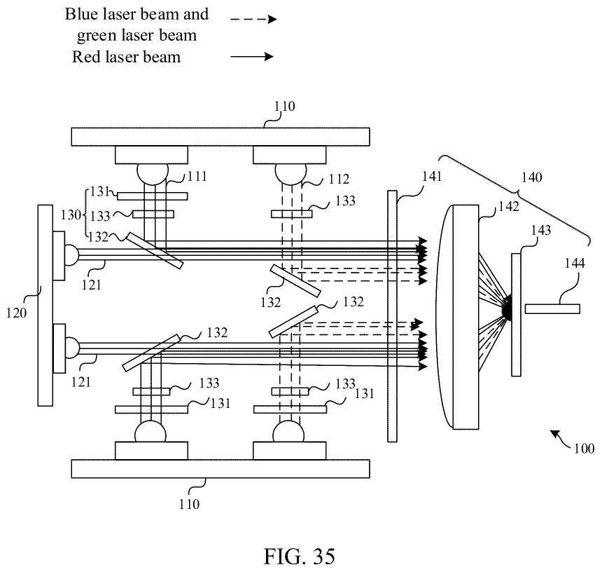

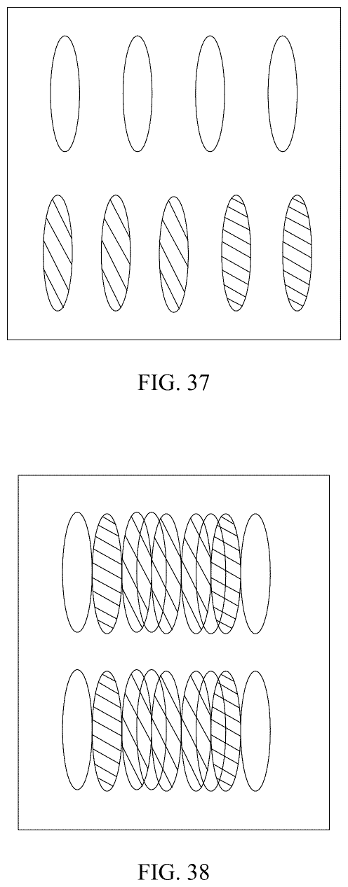

FIG. 32 to FIG. 36 are schematic structural diagrams of a laser light source apparatus according to embodiments of the present application. FIG. 37 is a schematic diagram of a light spot of a first laser before light combination according to embodiments of the present application. FIG. 38 is a schematic diagram of a light spot after light combination between the first laser and the second laser according to embodiments of the present application.

As shown in FIG. 32 to FIG. 38, a laser light source apparatus 100 according to embodiments of the present application includes following assemblies.

A first laser 110 is used for emitting laser beams with at least two different wavelengths, and different laser beams emitted from the first laser 110 have different polarization directions. The laser beam emitted from the first laser 110 includes a first laser beam 111 with a first wavelength.

It should be noted that the first laser 110 is a three-color laser. The first laser 110 may emit a red laser beam, a blue laser beam, and a green laser beam.

In addition, it should be noted that a polarization direction of the red laser beam is different from a polarization direction of the blue laser beam and a polarization direction of the green laser beam, and a wavelength of the red laser beam is different from a wavelength of the blue laser beam and a wavelength of the green laser beam

A second laser 120 is used for emitting a second laser beam 121 with the first wavelength. A polarization direction of the second laser beam 121 is the same as the polarization direction of the first laser beam 111.

It should be noted that the second laser 120 is a monochromatic laser. The monochromatic laser uses a single blue laser beam to excite yellow fluorescent powder and green fluorescent powder on a fluorescent color wheel, to generate red, green and blue laser beams.

Accordingly, the first laser 110, i.e., the three-color laser, employ red, green, and blue lasers to emit red, green and blue laser beams. Because the laser beam emitted from any laser in the three-color laser has good monochromaticity, as long as a laser with a proper wavelength is selected, it can be ensured that the emitted red, green and blue laser beams are almost free of stray light. Therefore, compared with the monochromatic laser, the three-color laser has advantages of high color gamut and high brightness, making it more and more widely used in laser projection devices.

In addition, it should be noted that each of the first laser beam 111 and the second laser beam 121 may be any one of a red laser beam, a green laser beam, and a blue laser beam, which can be adjusted according to actual situations, and there are no excessive restrictions here.

In embodiments of the present application, the second laser beam 121 is from a monochromatic laser. The main function of the second laser beam 121 is to complement a certain laser color for the laser light source apparatus 100, to increase brightness. Therefore, each of the first laser beam 111 and the second laser beam 121 can be a red laser beam, or a blue laser beam, or a green laser beam.

Of course, for the convenience of description, in embodiments of the present application, the second laser beam 121 is a red laser beam for example.

A polarization combining assembly 130 includes a polarization adjusting element 131 and a polarization light combining element 132. The polarization adjusting element 131 is arranged at a light emitting side of one of the first laser 110 and the second laser 120, to change the polarization direction of one of the first laser beam 111 and the second laser beam 121. The polarization light combining element 132 is at light emitting paths of the first laser 110 and the second laser 120. The polarization light combining element 132 is used for reflecting the laser beam of one of the first laser 110 and the laser beam of the second laser 120, and transmitting the laser beam of the other.

As shown in FIG. 32, the polarization adjusting element 131 is arranged at the light emitting side of the first laser 110 to change the polarization direction of the first laser beam 111. The polarization light combining element 132 is located at light emitting paths of the first laser 110 and the second laser 120. The polarization light combining element 132 is used for reflecting the laser beam of the first laser 110 and transmitting the laser beam of the second laser 120. In FIG. 32, two first lasers 110 are opposite to each other, and polarization adjusting and light combining schemes of the two first lasers 110 are the same. For illustration, the second laser 120 emits two (but not limited to two) laser beams for light combining with respective first lasers 110.

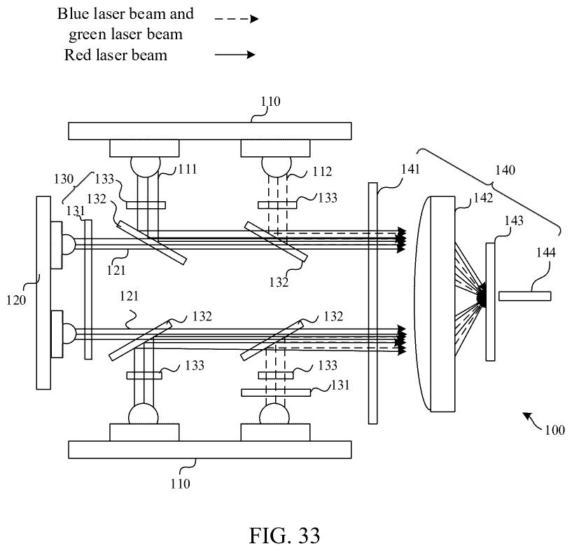

As shown in FIG. 33, the polarization adjusting element 131 is arranged at the light emitting side of the second laser 120 to change the polarization direction of the second laser beam 121. The polarization light combining element 132 is at light emitting paths of the first laser 110 and the second laser 120. The polarization light combining element 132 is used for reflecting the laser beam of the first laser 110 and transmitting the laser beam of the second laser 120.

It should be noted that the polarization adjusting element 131 is used for changing the polarization direction of one of the first laser beam 111 and the second laser beam 121, to polarize and combine the first laser beam 111 and the second laser beam 121. Regarding the position of the polarization adjusting element 131, embodiments of the present application are not to be unduly limited herein.

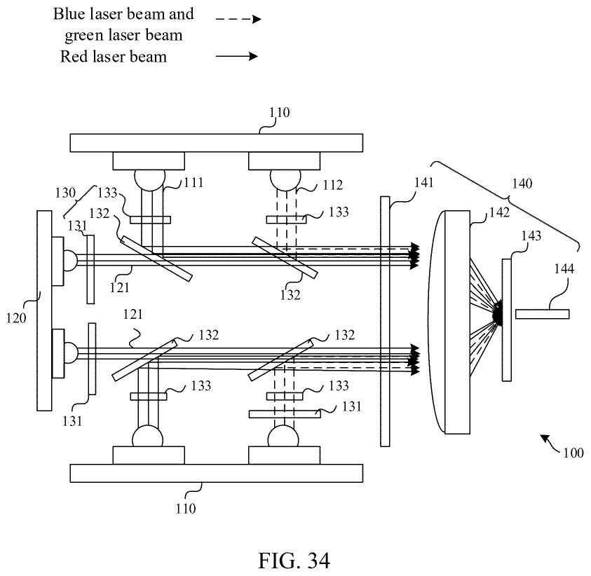

In addition, considering the convenience of processing or installation, as shown in FIG. 34, the polarization adjusting element 131 may be divided into two, respectively located at light emitting sides of two second laser beams 121 of the second laser 120.

It should be noted that because polarization modes of red laser beams emitted from the first laser beam 111 and the second laser beam 121 are the same, the first laser beam 111 and the laser beam emitted from the second laser 120 interfere with each other in the subsequent light path. As a result, the laser beams are easy to generate speckles in the subsequent light path, resulting in a poor display effect of the projection image projected by the laser projection device.

Therefore, in order to realize different polarization directions of the first laser beam 111 and the second laser beam 121 when the first laser beam 111 and the second laser beam 121 are projected to the polarization light combining element 132, in some embodiments, the polarization combining assembly 130 may further include a polarization adjusting element 131. The polarization adjusting element 131 is located at a light incident side of the polarization light combining element 132. The polarization adjusting element 131 is used for adjusting the polarization direction of the first laser beam 111 or the polarization direction of the second laser beam 121.

It should be noted that in the laser light source apparatus 100 according to embodiments of the present application, a polarization direction of the first laser beam 111 of the first laser 110 is controlled, so that the polarization direction of the first laser beam 111 of the first laser 110 and the polarization direction of the second laser beam 121 of the second laser 120 are changed from original same polarization direction to two different polarization directions, so that the polarization light combining element 132 combines the laser beams with different polarization directions, and guides the combined laser beam to a light homogenizing assembly 140. When polarization directions of laser beams are different, the speckle problem of the laser can be alleviated.

In addition, the first laser beam 111 and the second laser beam 121 have the same first wavelength which is the first wavelength. In this way, when the laser beams with the same wavelength and different polarization directions are projected to the polarization light combining element 132, the laser beam emitted from the polarization light combining element 132 has a small speckle problem.

The light homogenizing assembly 140 is used for homogenizing the laser beam emitted from the polarization light combining element 132.

It should be noted that laser beams are combined by the polarization light combining element 132, and then the light spot is adjusted by the light homogenizing assembly 140, leading to advantages of simple and compact structure and good light homogenizing effect.

Polarization directions of the first laser beam 111 in the first laser 110 and the second laser beam in the second laser 120 with the same wavelength and the same polarization direction as the first laser beam 111 are changed by the polarization adjusting element 131, so that the first laser beam 111 and the second laser beam 121 are laser beams with the same wavelength and different polarization directions, then the first laser beam 111 and the second laser beam 121 with different polarization directions are combined through a polarization light combining sheet, and the combined laser beam is guided to the light homogenizing assembly 140. When polarization directions of laser beams are different, the speckle problem of the laser can be alleviated. In addition, the added second laser 120 add a certain color to laser light source apparatus 100, to increase brightness of the laser light source apparatus 100. Meanwhile, this design can reduce the number of lenses, to reduce the manufacturing cost of the laser light source apparatus 100, and accordingly reduce the volume of the laser light source apparatus 100.

In some embodiments, as shown in FIG. 32 to FIG. 38, the laser beam emitted from the first laser 110 further includes a third laser beam 112 with a second wavelength. A polarization direction of the third laser beam 112 is different from the polarization direction of the first laser beam 111.

It should be noted that the second laser 120 is a monochromatic laser. The laser beam emitted from the second laser 120 may also a include a fourth laser beam with the second wavelength. The polarization direction of the third laser beam 112 is the same as a polarization direction of the fourth laser beam. The polarization direction of the fourth laser beam is different from the polarization direction of the second laser beam 121.

The second laser 120 can emit the second laser beam 121 or the fourth laser beam, and can be adjusted according to actual situations.

It should be noted that the third laser beam 112 can be in at least two rows. The third laser beam 112 includes a blue laser beam and a green laser beam. The fourth laser beam may be in at least two rows, and the fourth laser beam includes a blue laser beam and a green laser beam.

Polarization directions of the blue laser beam and the green laser beam of the third laser beam 112 are different from the polarization direction of the red laser beam of the first laser beam 111. Accordingly, polarization directions of the blue laser beam and the green laser beam of the fourth laser beam are different from the polarization direction of the red laser beam of the second laser beam 121.

In some embodiments, the polarization adjusting element 131 is arranged at an emergent light path of the first laser beam 111 of the first laser 110. The polarization adjusting element 131 is used for changing the polarization direction of the first laser beam 111.

The polarization adjusting element 131 is at the emergent light path of the first laser beam 111 of the first laser 110. Accordingly, the polarization adjusting element 131 is used for adjusting the polarization direction of the red laser beam in the first laser beam 111 from the polarization direction same to the polarization direction of the red laser beam in the second laser beam 121 to the polarization direction different from the polarization direction of the red laser beam in the second laser beam 121.

In some embodiments, the first laser beam 111 has a first polarization direction and the third laser beam 112 has a second polarization direction. The polarization adjusting element 131 is used for adjusting the first laser beam 111 with the first polarization direction to the first laser beam with the second polarization direction. The polarization adjusting element 131 is arranged at an emergent light path of a part of the third laser beam 112 of the first laser 110. The polarization adjusting element 131 is used for adjusting the part of the third laser beam 112 with the second polarization direction to the third laser beam 112 with the first polarization direction.

It should be noted that the first polarization direction is a P-polarization direction, and the second polarization direction is the S-polarization direction.

Accordingly, the polarization direction of the first laser beam 111 of the first laser 110 is the P-polarization direction. The polarization direction of the third laser beam 112 of the first laser 110 is the S-polarization direction. The polarization direction of the second laser beam 121 of the second laser 120 is the p-polarization direction. The polarization direction of the fourth laser beam of the second laser 120 is the S-polarization direction.

It should be noted that, the blue laser beam and the green laser beam of the third laser beam 112 and the red laser beam of the first laser beam 111 and the red laser beam of the second laser beam 121 are combined through wavelength-based light combining.

Of course, the blue laser beam and the green laser beam in the third laser beam 112 can also be combined through polarization-based light combining, which is not limited in embodiments of the application, and can be adjusted according to actual situations.

In this scenario, the first laser beam 111 and the second laser beam 121 are both red laser beams, and the polarization directions of the red laser beams in the first laser beam 111 and the second laser beam 121 in the current laser light source apparatus 100 are both P-polarization directions. Polarization directions of the blue laser beam and the green laser beam in the third laser beam 112 and the fourth laser beam are both S-polarization directions.

It should be noted that the P-polarization and the S-polarization are explained here for ease of understanding. When a light ray passes through a surface of an optical element at a non-normal angle, both reflection and transmission properties depend on polarization phenomena. In this case, a coordinate system used is defined by a plane containing input and reflected beams. If a polarization vector of the light ray is on this plane, it is called P-polarization, and if the polarization vector is perpendicular to this plane, it is called S-polarization.

In some embodiments, when the first laser beam 111 of the first laser 110 and the second laser beam 121 of the second laser 120 need to be combined, this means that the second laser beam 121 needs to supplemented for the laser light source apparatus 100 to increase brightness.

The polarization direction of the red laser beam in the first laser beam 111 can be adjusted from the P-polarization direction to the S-polarization direction. In this way, the polarization direction of the red laser beam projected from the first laser beam 111 to the polarization light combining element 132 is the S polarization direction. While the polarization direction of the red laser beam projected from the second laser beam 121 to the polarization light combining element 132 is still the P polarization direction, the polarization directions of the red laser beams are different when the red laser beams of the first laser 110 and the second laser 120 are projected to the polarization light combining element 132.

In some embodiments, when the third laser beam 112 of the first laser 110 and the fourth laser beam of the second laser 120 need to be combined, this means that the fourth laser beam needs to supplemented for the laser light source apparatus 100 to increase brightness.

The polarization directions of the blue laser beam and the green laser beam in the third laser beam 112 may be adjusted from the S-polarization direction to the P-polarization direction, In this way, the polarization directions of the blue laser beam and the green laser beam projected from the third laser beam 112 to the polarization light combining element 132 are P-polarization directions. While the polarization directions of the blue laser beam and the green laser beam projected from the second laser beam 121 to the polarization light combining element 132 are still the S polarization direction, the polarization directions of the beams are different respectively when the blue laser beam and the green laser beam of the first laser 110 and the second laser 120 are projected to the polarization light combining element 132.

In some embodiments, the polarization adjusting element 131 is a half-wave plate. By way of example, the polarization adjusting element 131 includes a half-wave plate. The half-wave plate can rotate the polarized light. Because linearly polarize light is perpendicularly incident to the half-wave plate, the transmitted light is still linearly polarized light. Suppose an angle between a vibration plane and a principal section of crystal at the time of incidence is θ, a vibration plane of the transmitted linearly polarized light is rotated by an angle of 2θ from the original orientation.

It should be noted that the polarization adjusting element 131 may be a ¼ wave plate.

As shown in FIGS. 32 to 38, the number of the first lasers 110 is two, and the two first lasers 110 are arranged at intervals along the first direction. The second laser 120 is located between the two first lasers 110. The first direction is the light emitting direction of the first lasers 110.

It should be noted that in order to improve the color gamut of the laser light source apparatus 100, two first lasers 110 are provided. The laser light source apparatus 100 has two three-color lasers, and a monochromatic laser, i.e., the second laser 120 is located between the two first lasers 110.

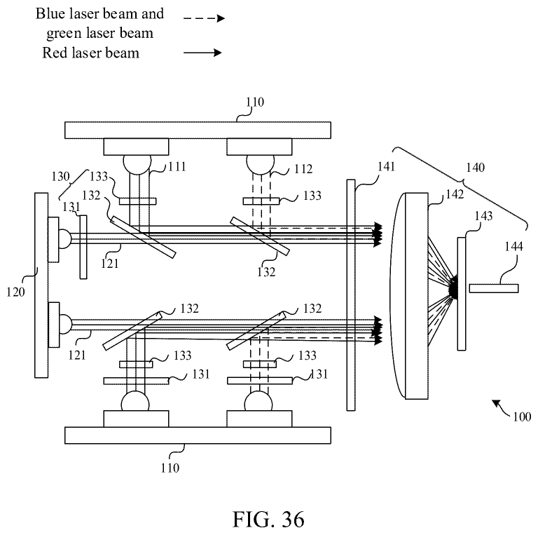

As shown in FIG. 36, the second laser beam 121 in the second laser 120 has at least two parts. A part of the polarization adjusting element 131 is located at a light emitting side of a part of the second laser beam 121 in the second laser 120, so that the part of the second laser beam 121 in the second laser 120 and the first laser beam 111 of one of the two first lasers 110 for which the polarization adjusting element 131 is not arranged are combined. The other part of the polarization adjusting element 131 is located at the light emitting side of the first laser beam 111 of one of the two first lasers 110, so that the second laser beam 121 in the second laser 120 for which the polarization adjusting element 131 is not arranged and the first laser beam 111 of one of the two first lasers 110 for which the polarization adjusting element 131 is arranged are combined.

In some embodiments, the second laser beam 121 needs to be supplemented for the laser light source apparatus 100 to increase the brightness. In particular, a part of the second laser beam 121 in second laser 120 and the first laser beam 111 of one of the two first lasers 110 are combined. The other part of the second laser beam 121 in the second laser 120 and the first laser beam 111 of the other of the two first lasers 110 are combined.

In some embodiments, the fourth laser beam needs to be supplemented for the laser light source apparatus 100 to increase the brightness. In particular, a part of the fourth laser beam in the second laser 120 and the third laser beam 112 of one of the two first lasers 110 are combined. The other part of the fourth laser beam in the second laser 120 and the third laser beam 112 of the other of the two first lasers 110 are combined.

It should be noted that when light combining is performed for the third laser beams 112 of the two first lasers 110, the polarization adjusting element 131 is required to adjust the polarization direction of the third laser beam 112 in any one of the two first lasers 110, so that the third laser beam 112 in any one of the two first lasers 110 is adjusted from an S-polarization direction to a P-polarization direction, and the third laser beam 112 in the other of the two first lasers 110 is still in the S-polarization direction, to realize that the polarization directions of the blue laser beam and the green laser beam when the other of the two first lasers 110 projects to the polarization light combining element 132, alleviating the speckle effect.

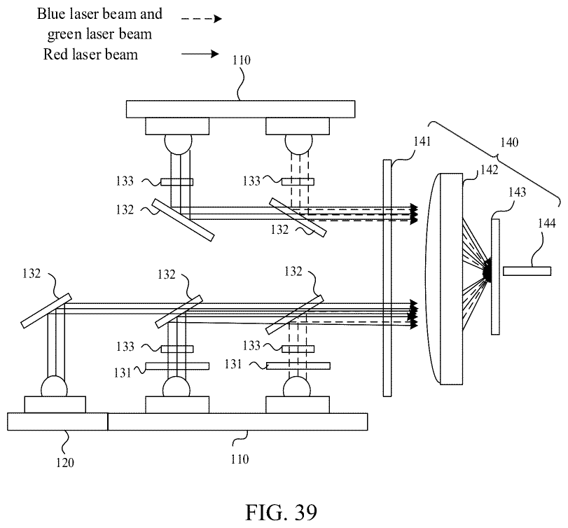

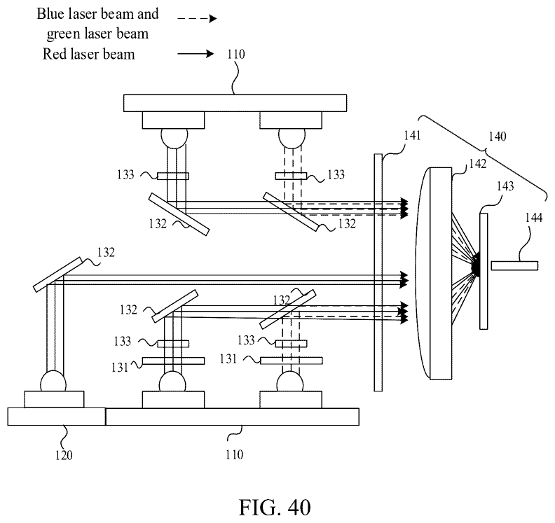

FIG. 39 and FIG. 40 are schematic structural diagrams of a laser light source apparatus according to embodiments of the present application.

In some embodiments, as shown in FIGS. 39 and 40, the second laser 120 and one of the first lasers 110 may be arranged side by side. If the second laser 120 in FIG. 39 is arranged at a side close to the light homogenizing assembly 140, a polarization light combining method is used for light combination. The specific light combining method may depend on the position of the second laser 120.

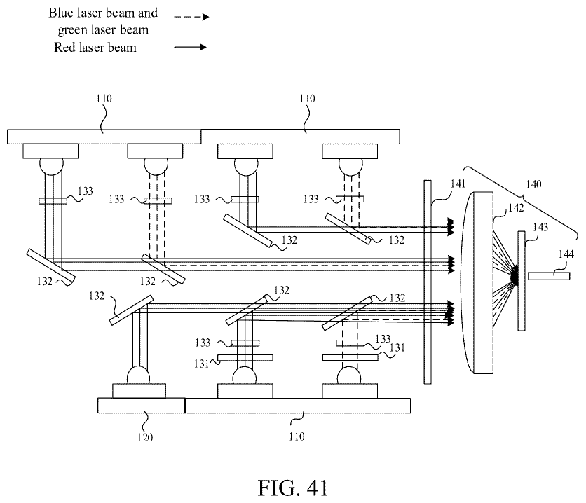

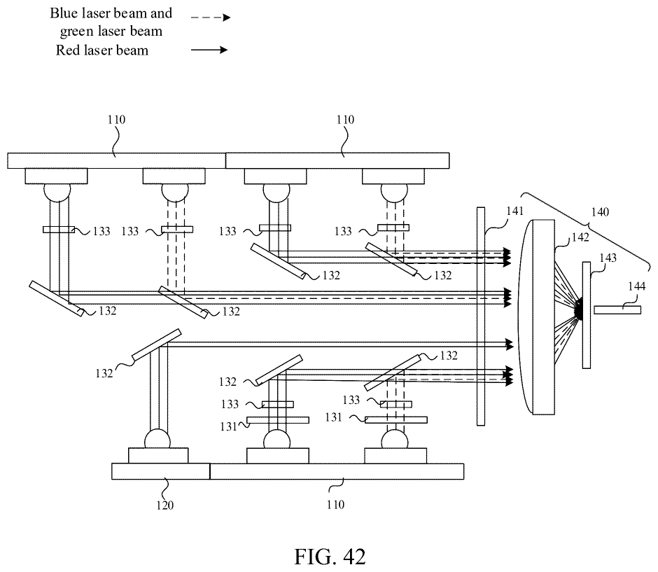

In some embodiments, as shown in FIGS. 41 and 42, there may be three first lasers 110.

In some embodiments, the polarization light combining assembly 130 further includes a prism 133. The prism 133 is located at a light incident side of the polarization light combining element 132. The prism 133 is used for adjusting a part of the laser beam.

It should be noted that the combined light is adjusted by the prism 133 to make the light spot more uniform. The prism 133 can adjust the direction and intensity of the light as needed to achieve the desired spot effect.

After the light combining assembly guides the laser beam adjusted by the prism 133 to the light homogenizing assembly 140, the laser beam can be better homogenized by the light homogenizing assembly 140, so that the homogenizing effect of the light homogenizing assembly 140 on the laser beams emitted from the first laser 110 and the second laser 120 is better. Further, it is possible to ensure that the display effect of the projection image projected by the laser projection device on which the laser light source apparatus 100 is mounted is good.

In some embodiments, as shown in FIG. 31 to FIG. 42, the light homogenizing assembly 140 includes a diffusion sheet 141, a lens 142, a diffusion wheel 143, and a light pipe 144. The diffusion sheet 141 is at a light emitting side of the polarization light combining element 132, and the lens 142 is located between the diffusion sheet 141 and the diffusion wheel 143. The polarization light combining element 132 is used for reflecting a laser beam to the diffusion sheet 141. The diffusion sheet 141 is used for uniformly projecting the received laser beam to the lens 142. The lens 142 is used for converging the received laser beam to the diffusion wheel 143. The diffusion wheel 143 is used for uniformly projecting the received light beam to the light pipe 144.

The diffusion sheet 141 can preliminarily homogenize the laser beam from the light combining assembly, and guide the preliminarily homogenized laser beam to the lens 142. The lens 142 may be located between the diffuser sheet 141 and the diffusion wheel 143. The lens 142 can converge the laser beam preliminarily homogenized by the diffusion sheet 141, and guide the converged laser beam to the diffusion wheel 143 in the light homogenizing assembly 140. The diffusion wheel 143 homogenizes the received laser beam again, and the homogenized laser beam is projected to the light pipe 144. The laser beam further homogenized by the light pipe 144 is finally homogenized, so that the homogenization effect of the laser beam is better.

The laser beam emitted from the polarization light combining element 132 may be emitted to the diffusion sheet 141. The diffusion sheet 141 is capable of homogenizing the incident laser beam and allowing the laser beam to be incident on the lens 142. The lens 142 is used for converging the laser beam emitted from the diffuser 141 to a light incident surface of the light pipe 144.

The diffusion wheel 143 (i.e. a rotatable diffusion sheet 141) is located between the lens 142 and the light pipe 144. The diffusion wheel 143 can diffuse the light beam in the convergent state, increase the divergence angle of the light beam, and increase the random phase.

In this way, since the diffusion sheet 141 is provided in the front-end light path, the laser beam is converged by the lens 142 after being homogenized, and is incident to the diffusion wheel 143. The laser beam first passes through a stationary diffusion sheet 141 and then passes through a moving diffusion sheet 141. The laser beam is diffused and homogenized again after the laser beam is homogenized by the stationary diffusion sheet 141. The homogenization effect of the laser beam can be enhanced, the energy ratio of the light beam near an optical axis of the laser beam is reduced, reducing the coherence degree of the laser beam and greatly improving the speckle phenomenon of a projection image.

In addition, the light pipe 144 is a hollow tubular piece, and the light is reflected inside the light pipe 144 for many times to achieve a uniform light effect. In this way, the laser light source apparatus 100 can shape the laser beam combined by the polarization light combining element 132 using the lens 142, so that the difference between the width of the light spot of the shaped laser beam in the direction of the slow axis of the laser and the width of the light spot of the shaped laser beam in the direction of the fast axis of the laser is small. Thus, after the shaped laser beam passes through the light pipe 144, the laser beam has a higher degree of uniformity.

In addition, it should be noted that this scheme can also be used in a fly-eye illumination system, which uses fly-eye instead of the light pipe 144 to homogenize light, and then incident on the illumination system.

It should be noted that when the light homogenizing assembly 140 includes a fly-eye lens, the laser beam emitted from the light combining assembly can be directly emitted to the fly-eye lens. The fly-eye lens can homogenize the laser beam emitted from each laser unit.

The laser light source apparatus according to embodiments of the present application includes a first laser and a second laser. The first laser is used for emitting laser beams with at least two different wavelengths, and different laser beams emitted from the first laser have different polarization directions. The laser beam emitted from the first laser includes a first laser beam with a first wavelength. The second laser is used for emitting a second laser beam with the first wavelength. The polarization direction of the second laser beam is the same as the polarization direction of the first laser beam. The polarization light combining assembly includes a polarization adjusting element and a polarization light combining element. The polarization adjusting element is arranged at a light emitting side of one of the first laser and the second laser, to change the polarization direction of one of the first laser beam and the second laser beam. The polarization light combining element is at emergent light paths of the first laser and the second laser. The polarization light combining element is used for changing reflecting one of the laser beam of the first laser and the laser beam of the second laser. The light homogenizing assembly is used for homogenizing the laser beam emitted from the polarization light combining element.

With the above arrangement, polarization directions of a first laser beam in a first laser and a second laser beam in a second laser with the same wavelength and the same polarization direction as the first laser beam are changed by a polarization adjusting element, so that the first laser beam and the second laser beam are laser beams with the same wavelength and different polarization directions, then the first laser beam and the second laser beam with different polarization directions are combined through a polarization light combining sheet, and the combined laser beam is guided to the light homogenizing element. When polarization directions of laser beams are different, the speckle problem of the laser can be alleviated. In addition, the added second laser can add a certain color to the whole laser light source apparatus, to increase brightness of the laser light source apparatus. Meanwhile, this design can reduce the number of lenses, to reduce the manufacturing cost of the laser light source apparatus, and accordingly reduce the volume of the laser light source apparatus.

In addition, embodiments of the present application further provide a laser light source apparatus 100, including: following assemblies.

A light emitting assembly includes a plurality of lasers. The plurality of lasers emit laser beams. A polarization light combining assembly 130 includes a polarization light combining element 132 and a polarization adjusting element 131. The polarization adjusting element 131 is used for adjusting polarization directions of parts of the laser beams of the plurality of laser sections, to adjust laser beams with the same polarization direction to laser beams with different polarization directions. The polarization light combining element 132 is used for combining the laser beams with different polarization directions. A light homogenizing assembly 140 is used for homogenizing the laser beam combined.

The laser light source apparatus according to embodiments of the present application includes: a light emitting assembly, where the light emitting assembly includes a plurality of lasers, and the plurality of lasers emit laser beams; a polarization light combining assembly, where the polarization light combining assembly includes a polarization light combining element and a polarization adjusting element, the polarization light combining element is used for adjusting polarization directions of the laser beams of the plurality of laser parts, to adjust laser beams with the same polarization direction to laser beams with different polarization directions, the polarization light combining element is used for combining the laser beams with different polarization directions; a light homogenizing assembly, where the light homogenizing assembly is used for homogenizing the laser beam combined.

polarization directions of a first laser beam in a first laser and a second laser beam in a second laser with the same wavelength and the same polarization direction as the first laser beam are changed by a polarization adjusting element, so that the first laser beam and the second laser beam are laser beams with the same wavelength and different polarization directions, then the first laser beam and the second laser beam with different polarization directions are combined through a polarization light combining sheet, and the combined laser beam is guided to the light homogenizing element. When polarization directions of laser beams are different, the speckle problem of the laser can be alleviated. In addition, the added second laser can add a certain color to the whole laser light source apparatus, to increase brightness of the laser light source apparatus. Meanwhile, this design can reduce the number of lenses, to reduce the manufacturing cost of the laser light source apparatus, and accordingly reduce the volume of the laser light source apparatus.

In addition, embodiments of the present application further provide a projection system, including: a laser light source apparatus 100, where the laser light source apparatus 100 is the laser light source apparatus 100 described above, the laser light source apparatus 100 is used for providing a laser beam to the opto-mechanical illumination system; a illumination system, for modulating the laser beam provided by the laser light source apparatus 100 into an image beam and emitting the image beam to a projection lens; the projection lens is used for imaging the image beam and then emitting the image beam to a projection screen.

The specific structure, working principle, and function of the laser light source apparatus 100 have been described in detail in the above embodiments, and are not repeated here.

Finally, although embodiments of the present application have been described, those of skill in the art may otherwise make various modifications and variations to these embodiments once they are aware of the basic inventive concept. Therefore, the claims intend to include embodiments as well as all these modifications and variations falling within the scope of the present application.

What is claimed is:

1. A laser light source apparatus, comprising:
a light emitting assembly, comprising a first laser and a second laser, wherein each of the first laser and the second laser comprises a plurality of laser chips for emitting laser beams of three colors, the first laser and the second laser are arranged along a first direction; the plurality of laser chips in each of the first laser and the second laser are arranged into a first light emitting region and a second light emitting region, and the first light emitting region and the second light emitting region are arranged along a second direction; wavelengths of laser beams emitted from the first light emitting region and the second light emitting region are different; the first light emitting region of the first laser and the second light emitting region of the second laser are arranged adjacently along the first direction, and are centrally aligned along the first direction; the second light emitting region of the first laser and the first light emitting region of the second laser are arranged adjacently along the first direction, and are centrally aligned along the first direction; the first direction and the second direction are perpendicular to each other; and
a light combining assembly, at light emitting sides of the first laser and the second laser, for combing a laser beam emitted from the first light emitting region of the first laser and a laser beam emitted from the second light emitting region of the second laser, and combining a laser beam emitted from the second light emitting region of the first laser and a laser beam emitted from the first light emitting region of the second laser, and emitting a laser beam combined along the first direction, wherein the first direction is parallel to a direction of a slow axis of the laser beam combined, a divergence angle of a laser beam, emitted from the laser chip, along a slow axis of the laser beam emitted from the laser chip is smaller than a divergence angle of the laser beam, emitted from the laser chip, along a fast axis of the laser beam emitted from the laser chip, a divergence angle of a laser beam, emitted from the light emitting assembly, along a slow axis of the laser beam emitted from the light emitting assembly is larger than a divergence angle of the laser beam, emitted from the light emitting assembly, along a fast axis of the laser beam emitted from the light emitting assembly.

2. The laser light source apparatus according to claim 1, wherein the first laser and the second laser are arranged side by side, and light emitting directions of the first laser and the second laser are the same;
the light combining assembly comprises: a first assembly and a second assembly, the first assembly is at light emitting sides of the first light emitting region of the first laser and the second light emitting region of the second laser, the second assembly is at light emitting sides of the second light emitting region of the first laser and the first light emitting region of the second laser;
the first assembly comprises: a first light reflecting piece, a first light combining piece and a second light reflecting piece; the first light reflecting piece is used for receiving the laser beam emitted from the second light emitting region of the second laser and reflecting the laser beam received to the first light combining piece, the first light combining piece is used for combining the laser beam received and emitted from the second light emitting region of the second laser and the laser beam emitted from the first light emitting region of the first laser, and emitting the laser beam combined to the second light reflecting piece, the second light reflecting piece is used for reflecting the laser beam combined and received along the first direction;
the second assembly comprises: a third light reflecting piece, a second light combining piece and a fourth light reflecting piece; the third light reflecting piece is used for receiving the laser beam emitted from the second light emitting region of the first laser and reflecting the laser beam received to the second light combining piece, the second light combining piece is used for combining the laser beam received and emitted from the second light emitting region of the first laser and the laser beam emitted from the first light emitting region of the second laser, and emitting the laser beam combined to the fourth light reflecting piece, the fourth light reflecting piece is used for reflecting the laser beam combined and received along the first direction.

3. The laser light source apparatus according to claim 2, wherein the plurality of laser chips comprises a plurality of first laser chips, a plurality of second laser chips, and a plurality of third laser chips; the first laser chip, the second laser chip, and the third laser chip emit laser beams of different wavelengths;
the plurality of first laser chips are in the first light emitting region and are arranged into a first laser chip row along the first direction, the plurality of second laser chips and the plurality of third laser chips are in the second light emitting region, and are arranged into a second laser chip row along the first direction; the first laser chip row and the second laser chip row are arranged in the second direction;
each of the first light reflecting piece and the third light reflecting piece is a transparent flat plate, the transparent flat plate comprises a first surface and a second surface parallel to each other, the first surface is arranged facing the second laser chip row and the second surface is arranged facing away from the second laser chip row;
the first surface is provided with a first film layer, and the first film layer is used for transmitting a laser beam emitted from the third laser chip, and reflecting a laser beam emitted from the second laser chip; the second surface is provided with a second film layer, and the second film layer is used for reflecting incident light; a refractive index and a thickness of the transparent flat plate satisfy a condition that a laser beam emitted from the third laser chip and incident from the first surface into the transparent flat plate is reflected from the second surface and then is emergent from a gap between laser beams emitted from the second laser chip and reflected from the first surface;
the refractive index and the thickness of the transparent flat plate satisfy:
$$2 a \leq \frac{d}{\sqrt{{n}^{2} - \frac{1}{2}}} \leq 3 a ;$$
wherein n represents the refractive index of the transparent flat plate, d represents the thickness of the transparent flat plate, and a represents a distance between two adjacent laser beams emitted from any one of the first laser and the second laser.

4. The laser light source apparatus according to claim 1, wherein the first laser and the second laser are arranged side by side, and light emitting directions of the first laser and the second laser are the same;
the light combining assembly comprises: a light reflecting piece and a light combining piece; the light reflecting piece is divided into an upper part and a lower part, and the light combining piece is divided into a first part and a second part;
the lower part of the light reflecting piece is used for receiving the laser beam emitted from the second light emitting region of the second laser and reflecting the laser beam received to the first part of the light combining piece, and receiving the laser beam emitted from the first light emitting region of the second laser and reflecting the laser beam received to the second part of the light combining piece, the first part of the light combining piece is used for combining the laser beam received and emitted from the second light emitting region of the second laser and the laser beam emitted from the first light emitting region of the first laser, and emitting the laser beam combined to the upper part of the light reflecting piece, the second part of the light combining piece is used for combining the laser beam received and emitted from the first light emitting region of the second laser and the laser beam emitted from the second light emitting region of the first laser, and emitting the laser beam combined to the upper part of the light reflecting piece, the upper part of the light reflecting piece is used for reflecting the laser beam combined and received along the first direction.

5. The laser light source apparatus according to claim 1, wherein the first laser and the second laser are arranged side by side, and light emitting directions of the first laser and the second laser are the same;
the light combining assembly comprises: a light reflecting piece and a light combining piece; the light combining piece is divided into a first part and a second part;
the light reflecting piece is used for receiving the laser beam emitted from the second light emitting region of the second laser and reflecting the laser beam received to the first part of the light combining part, receiving the laser beam emitted from the first light emitting region of the second laser and reflecting the laser beam received to the second part of the light combining piece; the first part of the light combining piece is used for combining the laser beam received and emitted from the second light emitting region of the second laser and the laser beam emitted from the first light emitting region of the first laser, and emitting the laser beam combined along the first direction, the second part of the light combining piece is used for combining the laser beam received and emitted from the first light emitting region of the second laser and the laser beam emitted from the second light emitting region of the first laser, and emitting the laser beam combined along the first direction.

6. The laser light source apparatus according to claim 1, wherein the first laser and the second laser are arranged perpendicularly, and light emitting directions of the first laser and the second laser are perpendicular to each other;
the light combining assembly comprises: a light reflecting piece and a light combining piece; the light combining piece is divided into a first part and a second part;
the first part of the light combining piece is used for receiving and combining the laser beam emitted from the first light emitting region of the first laser and the laser beam emitted from the second light emitting region of the second laser, and emitting the laser beam combined to the light reflecting piece; the second part of the light combining piece is used for receiving and combining the laser beam emitted from the second light emitting region of the first laser and the laser beam emitted from the first light emitting region of the second laser, and emitting the laser beam combined to the light reflecting piece; the light reflecting piece is used for receiving the laser beam combined and reflecting the laser beam combined along the first direction.

7. The laser light source apparatus according to claim 2, wherein the plurality of laser chips are divided into a plurality of first laser chips, a plurality of second laser chips and a plurality of third laser chips; the first laser chip, the second laser chip, and the third laser chip emit laser beams of different wavelengths;
the plurality of first laser chips are in the first light emitting region and are arranged into a first laser chip row along the first direction, the plurality of second laser chips and the plurality of third laser chips are in the second light emitting region, and are arranged into a second laser chip row along the first direction; the first laser chip row and the second laser chip row are arranged in the second direction;
the laser light source apparatus further comprises: a first prism and a second prism, the first prism is at a light emitting side of the second light emitting region of the second laser, the second prism is at a light emitting side of the second light emitting region of the first laser;
the first prism and the second prism are both used for transmitting a laser beam emitted from the second laser chip, transmitting a part of a laser beam emitted from the third laser chip, and transferring the other part of the laser beam emitted from the third laser chip to a side of the laser beam emitted from the second laser chip away from the other part of the laser beam emitted from the third laser chip for emitting.

8. The laser light source apparatus according to claim 2, wherein the plurality of laser chips are divided into a plurality of first laser chips, a plurality of second laser chips and a plurality of third laser chips; the first laser chip, the second laser chip, and the third laser chip emit laser beams of different wavelengths;
the plurality of first laser chips are in the first light emitting region and are arranged in two rows along the first direction, the plurality of second laser chips and the plurality of third laser chips are in the second light emitting region, the plurality of second laser chips are arranged in a row along the first direction, the plurality of third laser chips are arranged in a row along the first direction; the four laser chip rows are arranged along the second direction.

9. The laser source device according to claim 7, wherein the first laser chip is a red laser chip; the second laser chip is a green laser chip, and the third laser chip is a blue laser chip; the red laser chip is used for emitting a red laser beam, the green laser chip is used for emitting a green laser beam, and the blue laser chip is used for emitting a blue laser beam.

10. A laser light source apparatus, comprising:
a first laser and a second laser, wherein the first laser is used for emitting laser beams with at least two different wavelengths, and different laser beams emitted from the first laser have different polarization directions, the laser beam emitted from the first laser comprises a first laser beam with a first wavelength;
wherein the second laser is used for emitting a second laser beam with the first wavelength, a polarization direction of the second laser beam is the same as a polarization direction of the first laser beam;
a polarization light combining assembly, comprising a polarization adjusting element and a polarization light combining element, wherein the polarization adjusting element is arranged at a light emitting side of one of the first laser and the second laser, to change the polarization direction of one of the first laser beam and the second laser beam, the polarization light combining element is at light emitting paths of the first laser and the second laser, the polarization light combining element is used for reflecting the laser beam of one of the first laser and the second laser and transmitting the laser beam of the other one of the first laser and the second laser; and
a light homogenizing assembly, for homogenizing the laser beam emitted from the polarization light combining element.

11. The laser light source apparatus according to claim 10, wherein the laser beam emitted from the first laser comprises a third laser beam with a second wavelength, and a polarization direction of the third laser beam is different from the polarization direction of the first laser beam.

12. The laser light source apparatus according to claim 11, wherein the polarization adjusting element is at an emergent light path of the first laser beam of the first laser, and the polarization adjusting element is used for changing the polarization direction of the first laser beam.

13. The laser light source apparatus according to claim 12, wherein the first laser beam has a first polarization direction, and the third laser beam has a second polarization direction;
the polarization adjusting element is used for adjusting the first laser beam with the first polarization direction to the first laser beam with the second polarization direction;
the polarization adjusting element is at an emergent light path of a part of the third laser beam of the first laser, and the polarization adjusting element is used for adjusting the part of the third laser beam with the second polarization direction to the third laser beam with the first polarization direction.

14. The laser light source apparatus according to claim 10, wherein the polarization adjusting element is a half-wave plate.

15. The laser light source apparatus according to claim 10, wherein the laser light source apparatus comprises two first lasers, the two first lasers are arranged at intervals along the first direction, and the second laser is between the two first lasers, wherein the first direction is a light emitting direction of the first laser.

16. The laser light source apparatus according to claim 10, wherein the polarization light combining assembly further comprises a prism, and the prism is at a light incident side of the polarization light combining element and is used for adjusting a part of the laser beam.

17. The laser light source apparatus according to claim 10, wherein the light homogenizing assembly comprises a diffusion sheet, a lens and a diffusion wheel;
the diffusion sheet is at a light emitting side of the polarization light combining element, and the lens is between the diffusion sheet and the diffusion wheel;
the polarization light combining element is used for reflecting the laser beam to the diffusion sheet, the diffusion sheet is used for uniformly projecting the laser beam received to the lens, the lens is used for converging the laser beam received to the diffusion wheel.

18. A laser light source apparatus, comprising:
a light emitting assembly, comprising a plurality of lasers emitting laser beams;
a polarization light combining assembly, comprising a polarization light combining element and a polarization adjusting element, wherein the polarization adjusting element is used for adjusting polarization directions of parts of the laser beams of the plurality of lasers, to adjust laser beams with the same polarization direction to laser beams with different polarization directions, and the polarization light combining element is used for combining the laser beams with different polarization directions; and
a light homogenizing assembly, for homogenizing the laser beams combined.

19. A projection system, comprising the laser light source apparatus according to claim 1, an illumination system and a projection lens;
wherein the illumination system comprises a light homogenizing element, a shaping lens and a light modulator at a light emitting side of the laser light source apparatus;
the projection lens is at a light emitting side of the light modulator.
